(19) United States
(12) Patent Application Publication
(10) Pub. No.: US 2026/0042386 A1
(43) Pub. Date: Feb. 12, 2026

(54) VEHICLE SEAT

(71) Applicant: TS TECH CO., LTD., Asaka-shi, Saitama (JP)

(72) Inventors: Hajime YOSHIDA, Tochigi (JP); Takanori YAMAGUCHI, Tochigi (JP); Takayoshi ITO, Tochigi (JP); Hiroyuki KOZUTSUMI, Tochigi (JP); Toshiaki SHIMADA, Tochigi (JP); Jinichi TANABE, Tochigi (JP)

(21) Appl. No.: 19/102,071

(22) PCT Filed: Aug. 8, 2023
(86) PCT No.: PCT/JP2023/028970

§ 371 Date: Feb. 7, 2025

Related U.S. Application Data
(60) Provisional application No. 63/395,930, filed on Aug. 8, 2022.
(60) Provisional application No. 63/425,760, filed on Nov. 16, 2022.

(30) Foreign Application Priority Data
Jul. 20, 2023 (JP) 2023-118286

(51) Int. Cl. B60N 2/90; A61H 1/00; B60N 2/56; B60N 2/80; B60N 2/879

(52) U.S. Cl. CPC B60N 2/976; A61H 1/005; B60N 2/56; B60N 2/879; A61H 2201/0107; A61H 2201/0149; B60N 2002/899

(57) ABSTRACT

Provided is a vehicle seat equipped with a vibrator, and configured to enable simplification of a pad structure and facilitate assembly of the vibrator to the seat. The vehicle seat includes a frame, a pad supported by the frame and having a recess on a rear surface thereof, a vibrator disposed in the recess; and a sheet adhesively attached to the rear surface of the pad and spanning across the recess and the vibrator.

### TECHNICAL FIELD

The present invention relates to a vehicle seat.

### BACKGROUND ART

Patent Document 1 discloses a vehicle seat including a pad with a cutout space formed therein and a vibrator provided in the cutout space. This configuration of the vehicle seat allows the vibrator to be positioned close to a seated person while providing the pad interposed between the vibrator and the seated person.

### PRIOR ART DOCUMENT(S)

### Patent Document(s)

Patent Document 1: JP5104728B2

### SUMMARY OF THE INVENTION

### Task to be Accomplished by the Invention

Such a configuration in which a vibrator is installed inside a pad necessitates to form a space in the pad for accommodation of the vibrator, which complicates a shape of the pad. In addition, the configuration involves a problem that assembly of the seat requires an additional step of installing the vibrator in the space.

The present invention has been made in view of the problems of the prior art, and a primary object of the present invention is to provide a vehicle seat equipped with a vibrator, and configured to enable simplification of a pad structure and facilitate assembly of the vibrator to the seat.

### Means to Accomplish the Task

An aspect of the present invention provides a vehicle seat (1) comprising a frame (30), a pad (32) supported by the frame and having a recess (54) on a rear surface thereof, a vibrator (64) disposed in the recess; and a sheet (65) adhesively attached to the rear surface of the pad and spanning across the recess and the vibrator.

In this configuration, the recess for accommodating the vibrator opens at the rear surface of the pad, which facilitates the placement of the vibrator in the pad. In addition, the vibrator is held in the recess by the sheet adhesively attached to the pad, which enables the vibrator to be held in the pad in a stable manner. These features enable simplification of a pad structure and facilitate assembly of the vibrator to the seat.

The vehicle seat may be further configured such that the sheet is an adhesive tape and adhesively adhered to the rear surface of the pad and the vibrator.

This configuration facilitates the adhesive attachment of the sheet to the pad.

The vehicle seat may be further configured such that the vibrator is fitted into the recess.

This configuration facilitates transmission of vibration from the vibrator to the pad.

The vehicle seat may be further configured such that the pad and the frame form a seat back (3) that supports the back of an occupant, and wherein the vehicle seat further comprises a back cover (36) that is provided rearward of the frame with a gap therebetween.

In this configuration, the sound of vibration of the vibrator is less likely to be transmitted rearward of the vehicle seat.

The vehicle seat may be further configured such that the vehicle seat further comprises a pressure receiving member (50) in the frame, wherein the pressure receiving member supports the rear surface of the pad from the rear, and wherein the pressure receiving member and the vibrator face each other in a front-rear direction.

This configuration prevents the vibrator from coming off from the recess.

The vehicle seat may be further configured such that the pressure receiving member comprises a metal wire (51) that spans across the frame, and a plate-shaped member (52) supported by the metal wire and having surfaces that face front and rear, and wherein the plate-shaped member and the vibrator face each other in the front-rear direction.

This configuration enables the vibrator to be supported from the rear by the plate-shaped member in a stable manner.

The vehicle seat may be further configured such that the plate-shaped member has a plurality of wall cutouts (55) in a portion opposite the vibrator.

This configuration facilitates deformation of the portion of the plate-shaped member opposite to the vibrator, which allows the vibrator, when being pushed by an occupant's back, to move rearward. This prevents the occupant from feeling uncomfortable in the back by the vibrator.

The vehicle seat may be further configured such that the vehicle seat further comprises a pressure receiving member (50) in the frame, wherein the pressure receiving member has a hole (68) extending therethrough in a front-rear direction, wherein the pressure receiving member supports the rear surface of the pad from the rear, and wherein the vibrator is located to overlap the hole as viewed from the front or rear side.

This configuration allows the vibrator, when being pushed by an occupant's back, to move rearward, passing through the plate-shaped member. This prevents the occupant from feeling uncomfortable in the back by the vibrator.

The vehicle seat may be further configured such that the vibrator protrudes from the recess and extends through the hole.

When the vibrator is thicker than the depth of the recess, this configuration allows the pad to be brought into contact with the plate-shaped member, without interference between the vibrator and the plate-shaped member.

The vehicle seat may be further configured such that the pad and the frame form a seat back (3) that supports the back of an occupant, and wherein the seat back includes a main body (3A), a headrest (3B) integrally provided at an upper end of the main body, a neck pillow (3C) provided frontward of and extending over an upper portion of the main body and a lower portion of the headrest, the neck pillow projecting frontward with respect to the main body and the headrest, wherein the neck pillow has an air outlet (63) at a lower edge portion thereof, and wherein the vibrator is located downward of the air outlet.

In this configuration, the air outlet is positioned near the neck of an occupant. As a result, the temperature that the occupant feels is allowed to be regulated in an efficient manner. In addition, this configuration allows the vibrators to be placed in the pad without interference between the vibrator and the air outlet.

Patent Document 2 (JP2005-254972A) discloses a vehicle with a vehicle control device for operating in-vehicle devices such as air conditioners or audio devices. The vehicle control device has a plurality of switch elements (input devices) for receiving various operations. Each switch element is provided on an armrest of a driver's seat (vehicle seat).

Patent Document 2 does not teach any specifics about how each switch element is supported by an armrest. In this case, when an occupant places their arm on the armrest, a load can be applied to the switch elements, which leads to a risk that the occupant's unintended operation is received.

Thus, according to one aspect of the present invention, an object of the invention is to prevent a load from being applied to an input device.

As a solution to the above-described tasks to be accomplished, an aspect of the present invention provides a vehicle seat (1) comprising a seat cushion (2), a seat back (3) supported by the seat cushion, and an armrest (5) extending frontward from the seat back, wherein the armrest comprises an armrest frame (74) that serves as a structural frame, an armrest body (75) supported by the armrest frame, and an input device (79) supported by the armrest body, wherein the armrest body has a recess (75E) that is recessed downward from the top surface, and wherein the input device is accommodated in the recess.

In this configuration, the load applied to the armrest is transmitted to the armrest body. Thus, no load is applied to the input device, which prevents the occupant's unintended operation from being received.

The above vehicle seat may be further configured such that a space (75D) is formed inside the armrest body, such that a harness (79) connected to the input device and the armrest frame may be provided in the space.

In this configuration, the harness can be routed through the space where the armrest frame is located. Thus, the structure that allows the harness to be placed, can be made simple.

The above vehicle seat may be further configured such that the armrest body further has a reinforcing member (76) provided along the inner surface that defines the space.

This configuration allows the reinforcing member to receive a load applied to the armrest body, which increases the rigidity of the armrest body.

The above vehicle seat may be further configured such that the armrest body further includes a partition wall (77) that divides the space into left and right subspaces, and the armrest frame may be provided in the space on one of the left and right subspaces, and the harness may be placed in the space on the other subspace.

This configuration prevents interference between the harness and the armrest frame.

The above vehicle seat may be further configured such that the recess has a bottom part (75F) and a pair of side parts (75G) extending upward from the left and right edges of the bottom part, and the upper edges of the left and right side walls are located above the upper edge of the input device.

In this configuration, since the input device is positioned below the top of the armrest body, a load applied to the armrest is transmitted to the armrest body.

### Effect of the Invention

As a solution to the above-described tasks to be accomplished, the present invention can be embodied as a vehicle seat (1) comprising a frame (30), a pad (32) supported by the frame and having a recess (54) on a rear surface thereof, a vibrator (64) disposed in the recess; and a sheet (65) adhesively attached to the rear surface of the pad and spanning across the recess and the vibrator.

In this configuration, the recess for accommodating the vibrator opens at the rear surface of the pad, which facilitates the placement of the vibrator in the pad. In addition, the vibrator is held in the recess by the sheet adhesively attached to the pad, which enables the vibrator to be held in the pad in a stable manner. These features enable simplification of a pad structure and facilitate assembly of the vibrator to the seat.

The vehicle seat may be further configured such that the sheet is an adhesive tape and adhesively adhered to the rear surface of the pad and the vibrator.

This configuration facilitates the adhesive attachment of the sheet to the pad.

The vehicle seat may be further configured such that the vibrator is fitted into the recess.

This configuration facilitates transmission of vibration from the vibrator to the pad.

The vehicle seat may be further configured such that the pad and the frame form a seat back (3) that supports the back of an occupant, and wherein the vehicle seat further comprises a back cover (36) that is provided rearward of the frame with a gap therebetween.

In this configuration, the sound of vibration of the vibrator is less likely to be transmitted rearward of the vehicle seat.

The vehicle seat may be further configured such that the vehicle seat further comprises a pressure receiving member (50) in the frame, wherein the pressure receiving member supports the rear surface of the pad from the rear, and wherein the pressure receiving member and the vibrator face each other in a front-rear direction.

This configuration prevents the vibrator from coming off from the recess.

The vehicle seat may be further configured such that the pressure receiving member comprises a metal wire (51) that spans across the frame, and a plate-shaped member (52) supported by the metal wire and having surfaces that face front and rear, and wherein the plate-shaped member and the vibrator face each other in the front-rear direction.

This configuration enables the vibrator to be supported from the rear by the plate-shaped member in a stable manner.

The vehicle seat may be further configured such that the plate-shaped member has a plurality of wall cutouts (55) in a portion opposite the vibrator.

This configuration facilitates deformation of the portion of the plate-shaped member opposite to the vibrator, which allows the vibrator, when being pushed by an occupant's back, to move rearward. This prevents the occupant from feeling uncomfortable in the back by the vibrator.

The vehicle seat may be further configured such that the vehicle seat further comprises a pressure receiving member (50) in the frame, wherein the pressure receiving member has a hole (68) extending therethrough in a front-rear direction, wherein the pressure receiving member supports the rear surface of the pad from the rear, and wherein the vibrator is located to overlap the hole as viewed from the front or rear side.

This configuration allows the vibrator, when being pushed by an occupant's back, to move rearward, passing through the plate-shaped member. This prevents the occupant from feeling uncomfortable in the back by the vibrator.

The vehicle seat may be further configured such that the vibrator protrudes from the recess and extends through the hole.

When the vibrator is thicker than the depth of the recess, this configuration allows the pad to be brought into contact with the plate-shaped member, without interference between the vibrator and the plate-shaped member.

The vehicle seat may be further configured such that the pad and the frame form a seat back (3) that supports the back of an occupant, and wherein the seat back includes a main body (3A), a headrest (3B) integrally provided at an upper end of the main body, a neck pillow (3C) provided frontward of and extending over an upper portion of the main body and a lower portion of the headrest, the neck pillow projecting frontward with respect to the main body and the headrest, wherein the neck pillow has an air outlet (63) at a lower edge portion thereof, and wherein the vibrator is located downward of the air outlet.

In this configuration, the air outlet is positioned near the neck of an occupant. As a result, the temperature that the occupant feels is allowed to be regulated in an efficient manner. In addition, this configuration allows the vibrators to be placed in the pad without interference between the vibrator and the air outlet.

### BRIEF DESCRIPTION OF THE DRAWINGS

FIG. 1 is a perspective view of a seat according to an embodiment of the present invention;

FIG. 2 is a front view showing a lower part of the seat;

FIG. 3 is a front view showing a seat back;

FIG. 4 is a side cross-sectional view showing an upper portion of the seat back (a cross section taken along line IV-IV in FIG. 1);

FIG. 5 is a side cross-sectional view showing a center portion of the seat back (a cross section taken along line V-V in FIG. 1);

FIG. 6 is a side cross-sectional view showing an important part of the center portion of the seat back;

FIG. 7 is a front view showing a variation of the seat back;

FIG. 8 is a side cross-sectional view showing a center portion of the variation of the seat back;

FIG. 9 is a side cross-sectional view showing a center portion of the variation of the seat back;

FIG. 10 is a perspective view showing a reclining mechanism and a rotation mechanism;

FIG. 11 is a front view showing the reclining mechanism and the rotation mechanism;

FIG. 12 is a perspective view showing the reclining mechanism and the rotation mechanism;

FIG. 13 is a perspective view showing an important part of a rear portion of the right armrest,

FIG. 14 is a perspective view showing an important part of a front portion of the right armrest,

FIG. 15 is a front view showing another variation of the seat back;

FIG. 16 is a diagram illustrating a system for armrest coordination control;

FIG. 17 is a side view illustrating armrest coordination control;

FIG. 18 is a flow chart illustrating the armrest coordination control;

FIG. 19 is a side view illustrating a variation of the armrest coordination control;

FIG. 20 is a perspective view showing a variation of the rotation mechanism;

FIG. 21 is a front view showing another variation of the seat back;

FIG. 22 is a plan view showing a variation of the seat cushion;

FIG. 23 is a front view showing another variation of the seat back;

FIG. 24 is a cross-sectional view showing an important part of another variation of the seat back;

FIG. 25 is a front view showing another variation of the seat back;

FIG. 26 is a front view showing another variation of the seat back;

FIG. 27 is a side view showing another variation of the seat;

FIG. 28 is a block diagram illustrating a system for rotation control of the seat;

FIG. 29 is a flow chart illustrating the rotation control;

FIG. 30 is a block diagram showing a variation of the system for rotation control of the seat; and

FIG. 31 is a flow chart of a variation of the rotation control.

### DESCRIPTION OF THE PREFERRED EMBODIMENT(S)

Embodiments of a vehicle seat according to the present invention, in which the vehicle seat is used in a seat 1 of an automobile, will be described with reference to the appended drawings. In the following description, the front/rear, left/right, and vertical directions are defined relative to a vehicle equipped with the vehicle seat.

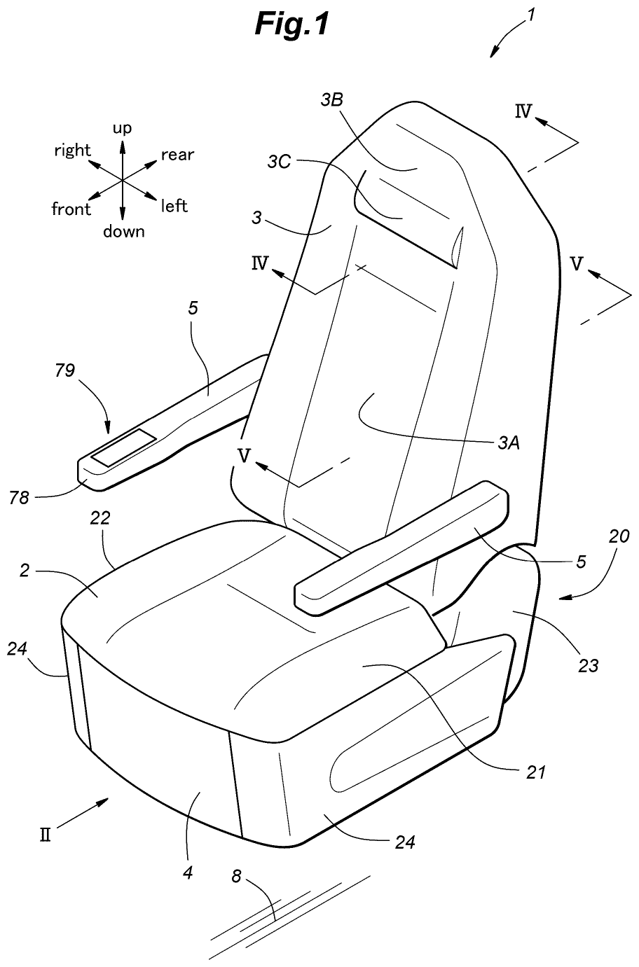

As shown in FIG. 1, a seat 1 includes a seat cushion 2, a seat back 3, an ottoman 4, a left and right pair of armrests 5, and a rotating device 6. The rotating device 6 is provided between the seat cushion 2 and a floor 8 of a vehicle. The rotating device 6 may be provided on the floor 8 of the vehicle via a slide rail. The seat cushion 2 supports the buttocks and thighs of an occupant from below.

The seat back 3 is provided at a rear part of the seat cushion 2. The seat back 3 is rotatable with respect to the seat cushion 2. The seat back 3 includes a body 3A, a headrest 3B integrally provided at the upper end of the body 3A, and a neck pillow 3C provided at a position frontward of the upper part of the body 3A and the lower part of the headrest 3B. The body 3A supports the back of an occupant from the rear. The headrest 3B supports the head of an occupant from the rear. The neck pillow 3C supports the neck of an occupant from the rear.

The ottoman 4 is positioned at a front part of the seat cushion 2. The ottoman 4 may be provided to be rotatable with respect to the seat cushion 2. The ottoman 4 supports the lower legs of an occupant from the front. Each of the left and right armrests 5 extends frontward on the left and right side parts of the seat back 3. Each of the armrests 5 is rotatable with respect to the seat back 3. The armrests 5 support an occupant's arms from the below.

The rotating device 6 includes a base member 10 configured to be provided on the floor 8 and a support member 11 rotatably supported by the base member 10 and is rotatable around a vertical axis. The rotating device 6 may have a rotation drive mechanism 12 configured to rotate the support member 11 with respect to the base member 10.

The seat cushion 2 includes a seat cushion frame 20 that serves as a structural frame, a seat cushion pad 21 that serves as a pad supported by the seat cushion frame 20, and a seat cushion cover 22 for covering an outer surface of the seat cushion pad 21. The seat cushion frame 20 may be of a known configuration, such as one including a pair of left and right seat cushion side members 23, a front member joined to the front ends of the left and right seat cushion side members 23, a rear member joined to the rear ends of the left and right seat cushion side members 23, and a pressure receiving member that spans across the front and rear members. The seat cushion 2 is joined to the support member 11.

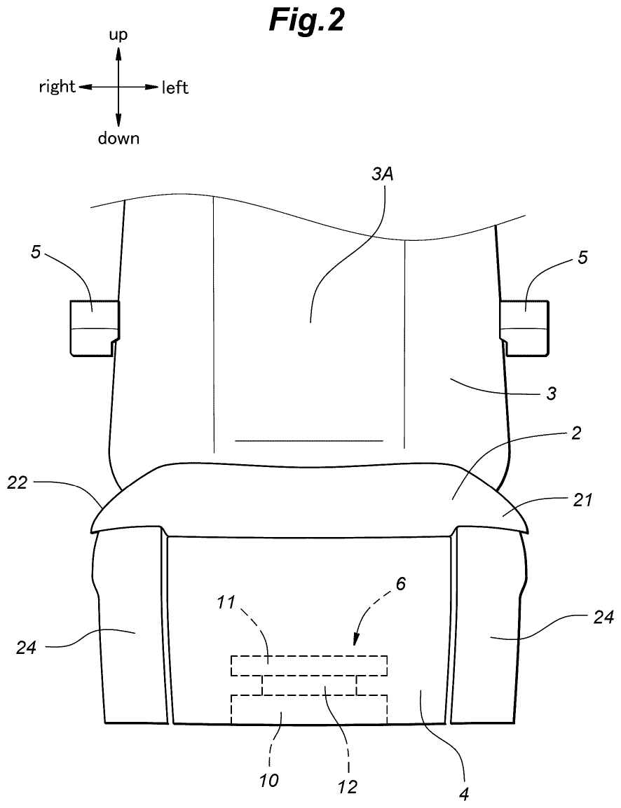

As shown in FIG. 2, the seat cushion 2 has a pair of left and right side covers 24. The side covers 24 may be formed of plastics material. Each of the side covers 24 covers the front end of the corresponding seat cushion side member 23 from the outer side of the seat in the left-right direction, where the terms “outer”, “inner”, and “width” are defined herein along the left-right direction of the seat. The left and right side ends of the seat cushion pad 21 extend above the corresponding side covers 24, as viewed from the front. In other words, the left and right edges of the seat cushion pad 21 are arranged above the corresponding side covers 24. Preferably, the left and right side edges of the seat cushion pad 21 are arranged along the left and right outer edges of the corresponding side covers 24. This arrangement causes the seat cushion 2 to appear wider.

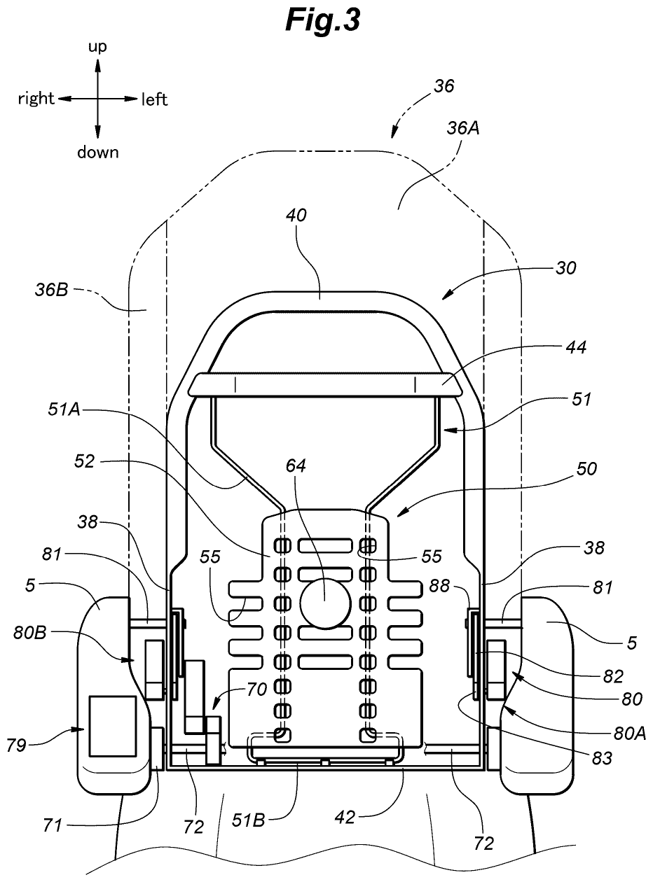

As shown in FIGS. 1 and 3, the seat back 3 includes a seat back frame 30 that serves as a structural frame, a seat back pad 32 that serves as a pad supported by the seat back frame 30, and a skin 34 that covers the seat back pad 32 and the seat back frame 30. The seat back 3 also includes a seat back cover 36 provided at the rear of the seat back frame 30 that serves as a rear cover.

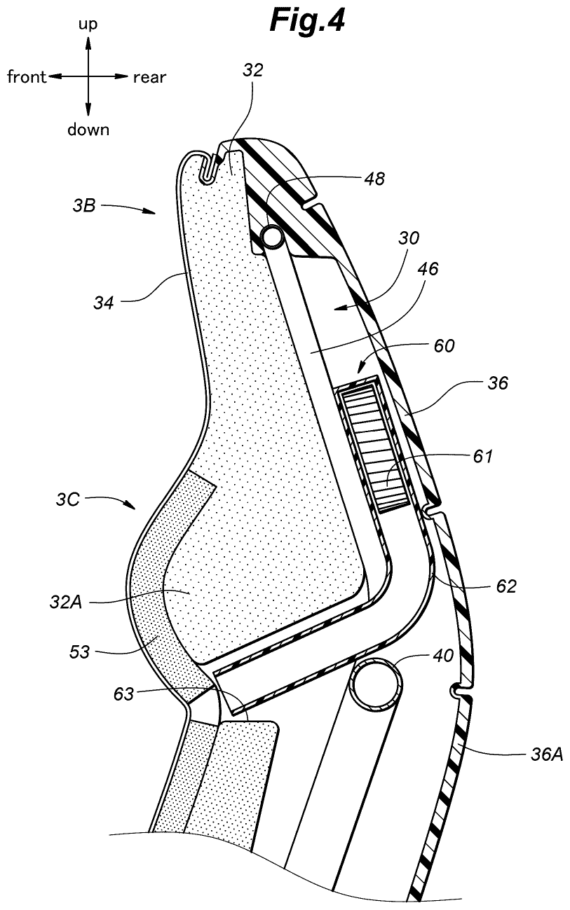

As shown in FIGS. 3 and 4, the seat back frame 30 includes a pair of left and right seat back side members 38 that extend vertically. The seat back frame 30 also includes an upper member 40 that extends horizontally and is coupled to the upper ends of the left and right seat back side members 38, and a lower member 42 that is connected to the lower ends of the left and right seat back side members 38. The seat back frame 30 further includes a middle member 44 that extends horizontally between the upper member 40 and the lower member 42 and is connected to the left and right seat back side members 38. The seat back frame 30 also has a pair of left and right pillars 46 that extend upward from the upper member 40, and a connecting member 48 that extends horizontally and is connected to the upper ends of the left and right pillars 46. The seat back side members 38, the upper member 40, the lower member 42, and the middle member 44 are components manufactured by the bending and forming of a metal plate.

A pressure receiving member 50 is provided at a location on the inner side of the seat back frame 30. The pressure receiving member 50 is also called as a lumbar support. The pressure receiving member 50 includes a metal wire 51 that extends across the seat back frame 30, and a plate-shaped member 52 that is supported by the wire 51 and faces frontward and rearward. In the present embodiment, the wire 51 may have a pair of left and right vertical wire portions 51A that extend in an up-down direction, and a lower wire portion 51B that connects the lower end parts of the pair of left and right vertical wire portions 51A. The lower wire portion 51B is connected to the lower member 42. The upper ends of the left and right vertical wire portions 51A are connected to the middle member 44. The plate-shaped member 52 is connected to the left and right vertical wire portions 51A at their middle parts of 51A in the up-down direction. The plate-shaped member 52 may be formed of plastics material. The plate-shaped member 52 has a plurality of cutout holes 55 (wall cutouts) that extend through in the front-rear direction. Some of the cutout holes 55 may extend in a left-right direction of the seat to reach either of the left and right side ends of the plate-shaped member 52. The cutout holes 55 increase the flexibility of the plate-shaped member 52.

The seat back pad 32 extends in the up-down direction. The seat back pad 32 may be formed of foamed plastics material. The seat back pad 32 is arranged to cover the seat back frame 30 as viewed from the front. The seat back pad 32 has a front surface facing an occupant and a rear surface facing the rear. The rear surface of the seat back pad 32 is supported from the rear by the pressure receiving member 50.

As shown in FIG. 4, the neck pillow 3C is formed of a protrusion member 32A which protrudes frontward from the surface of the seat back pad 32. The protrusion member 32A has a front surface covered with the skin 34. The protrusion member 32A extends in the left-right direction. The front surface of the protrusion member 32A is bent to form a curve and protrudes frontward, as viewed from either of the left and right. The neck pillow 3C has a lower end, which is positioned at generally the same height as the upper member 40. Similarly, the neck pillow 3C is positioned at the same height as the lower ends of the pillars 46. The surface of the protrusion member 32A may be formed of a pad member 53 which is different from the seat back pad 32. For example, the pad member 53 and the seat back pad 32 may be formed of plastics materials having different elastic moduli.

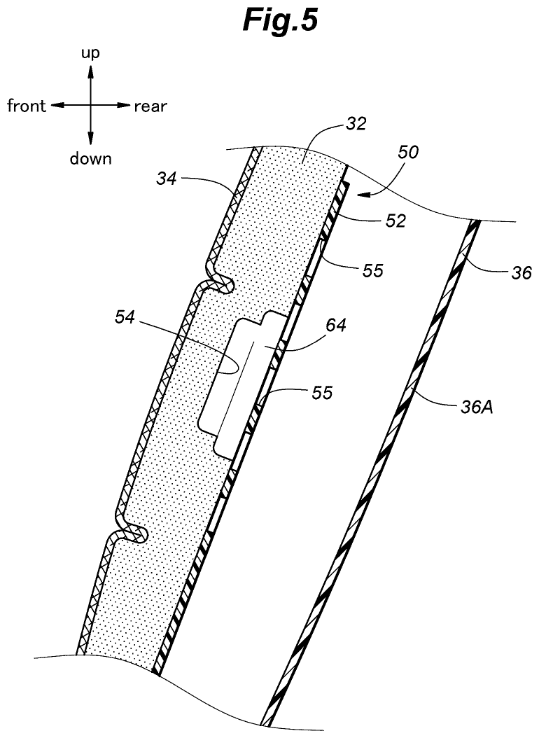

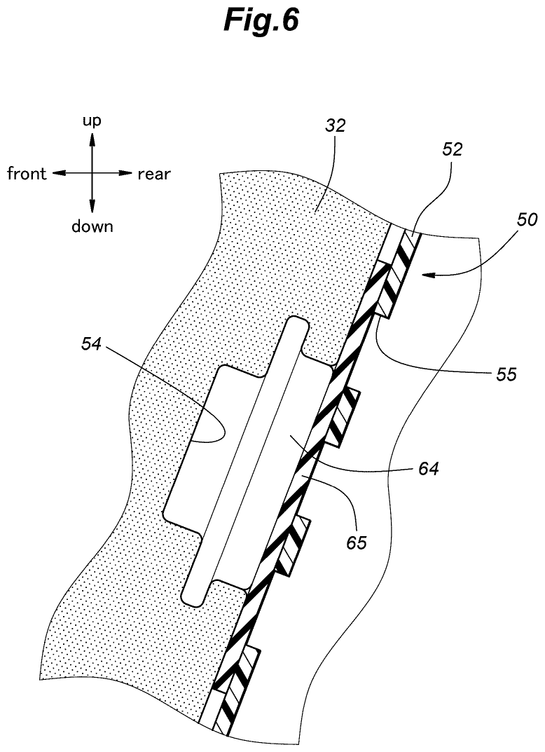

As shown in FIGS. 5 and 6, a recess 54 is formed on the rear surface of the seat back pad 32. The recess 54 is recessed frontward from the rear surface of the seat back pad 32.

As shown in FIGS. 3 to 5, the seat back cover 36 is connected to the rear of the seat back frame 30. The seat back cover 36 forms an outer surface of the rear of the seat back 3. The seat back cover 36 may be formed of, for example, plastics material. The seat back cover 36 has a central portion 36A and left and right side portions 36B extending frontward from both the left and right ends of the central portion 36A. The central portion 36A has a front-facing surface and a rear-facing surface. As shown in FIG. 5, the central portion 36A is provided to form a gap between the central portion 36A and the rear surface of the seat back pad 32. Similarly, the central portion 36A is provided to form a gap between the central portion 36A and the rear of the pressure receiving member 50. The left and right side portions 36B have surfaces which face the corresponding left and right directions. The side portions 36B cover the corresponding seat back side members 38 from the left and right outer sides, respectively.

As shown in FIG. 4, the seat back 3is provided with an air blowing device 60. The air blowing device 60 includes a blower 61, a duct 62 communicatively connected to the blower 61, and an air outlet 63 communicatively connected to the duct 62. The blower 61 may be a sirocco fan, for example. The blower 61 is attached to the rear of the left or right pillar 46. The blower 61 may be attached to the rear of the connecting member 48. The blower 61 has a blower outlet, which is communicatively connected to one end of the duct 62 (a first end of the duct 62). The duct 62 extends, passing through between the left and right pillars 46 to extend toward the front of the pillars 46. The other end of the duct 62 (second end of the duct 62) is communicatively connected to the air outlet 63. The air outlet 63 is formed in the seat back pad 32.

The air outlet 63 is positioned at the lower end of the neck pillow 3C. The air outlet 63 extends through the seat back pad 32 from the rear to the front thereof. The second end of the duct 62 may be inserted into the air outlet 63. The air outlet 63 is positioned near the neck of an occupant, resulting in that the temperature that the occupant feels is allowed to be regulated in an efficient manner.

As shown in FIGS. 5 and 6, the seat 1 has at least one vibrator 64. The vibrator 64 may be of a known configuration including, for example, a coil, a magnet and a yoke. The coil may be electrically connected to a power source (not shown) in a vehicle via a harness (not shown). As the direction of a current flowing through the coil periodically changes, the magnetic field generated by the coil changes. As a result, the yoke coupled to the magnet vibrates in response to the change in the magnetic field. In a preferable embodiment, the vibrator 64 may be arranged such that the direction of the vibration is perpendicular to the surface of the seat back pad 32. In some cases, the vibrator may be arranged so that the direction of the vibration is parallel to the surface of the seat back pad 32. In other embodiments, the vibrators 64 may be speakers for transmitting sound to an occupant.

The vibrator 64 is provided in the recess 54 formed on the rear surface of the seat back pad 32. The vibrator 64 faces the pressure receiving member 50 in the front-rear direction. The vibrator 64 also faces the plate-shaped member 52 in the front-rear direction. More specifically, the vibrator 64 faces the cutout holes 55. This allows the vibrator 64 to be stably supported from the rear by the plate-shaped member 52. Furthermore, the vibrator 64 is disposed below the air outlet 63. As a result, the vibrator 64 is disposed on the seat back pad 32 without interference with the air outlet 63. The vibrator 64 preferably fits into the recess 54. When the vibrator 64 is fitted into the recess 54, the rear surface of the vibrator 64 is preferably flush with the rear surface of the seat back pad 32. As shown in FIG. 6, a sheet 65 is attached to the rear surface of the seat back pad 32 to span across and extend over the recess 54 and the vibrator 64. The sheet 65 is an adhesive tape, and is adhesively attached to the rear surface of the seat back pad 32 and the vibrator 64.

Next, a method of assembling the vibrator 64 will be described. First, a seat back pad 32 is prepared as shown in FIGS. 5 and 6. The seat back pad 32 is shaped by a molding process to have a recess 54 on the back surface. The vibrator 64 is then fitted into the recess 54 formed in the seat back pad 32. Next, a sheet 65 is adhesively attached to the rear surface of the seat back pad 32 so that the vibrator 64 is fixedly held in the seat back pad 32. Next, the seat back pad 32 is attached to the seat back frame 30 to which the pressure receiving member 50 is attached. The seat back pad 32 is disposed on the front faces of the seat back frame 30 and the pressure receiving member 50. As a result, the seat back pad 32 is supported by the seat back frame 30 and the pressure receiving member 50. Next, the skin 34 is placed over the seat back pad 32 and the seat back frame 30. Then, the seat back cover 36 is attached to the rear of the seat back frame 30.

As shown in FIGS. 5 and 6, the recess 54 for accommodating the vibrator 64 opens at the rear surface of the seat back pad 32, which facilitates the placement of the vibrator 64 in the seat back pad 32. In addition, the vibrator 64 is held in the recess 54 by the sheet 65 adhesively attached to the seat back pad 32, which enables the vibrator 64 to be held in the seat back pad 32 in a stable manner. These features enable simplification of a pad structure of the seat back pad 32 and facilitate the assembly of the vibrator 64 to the seat. In some cases, the sheet 65 is an adhesive tape, which facilitates the adhesive attachment of the sheet 65 to the seat back pad 32.

The vibrator 64 fits into the recess 54, which facilitates transmission of vibration 64 from the vibrator to the seat back pad 32. Moreover, this feature also allows the relative position of the vibrator 64 to the seat back 3 to be stable.

The seat back cover 36 is provided rearward of the vibrator 64 with a gap therebetween. This feature causes the sound of vibration of the vibrator 64 to be less likely to be transmitted rearward of the seat 1.

The vibrator 64 faces the pressure receiving member 50 in the front-rear direction. This feature prevents the vibrator 64 from coming off from the recess 54.

The cutout holes 55 increase the flexibility of the plate-shaped member 52. This feature facilitates deformation of the portion of the plate-shaped member 52 opposite to the vibrator 64, which allows the vibrator 64, when being pushed by an occupant's back, to move rearward, thereby preventing the occupant from feeling uncomfortable in the back by the vibrator 64.

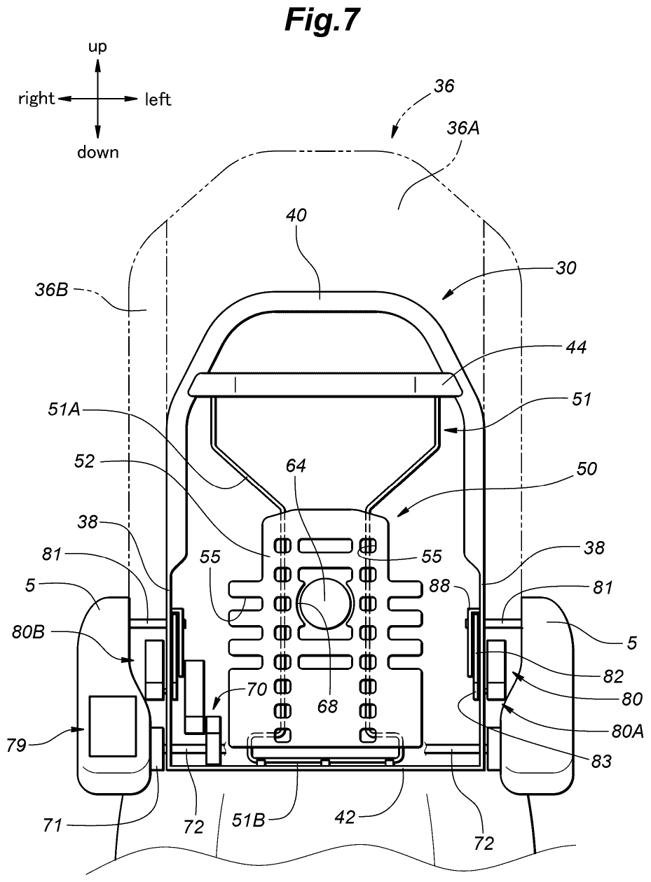

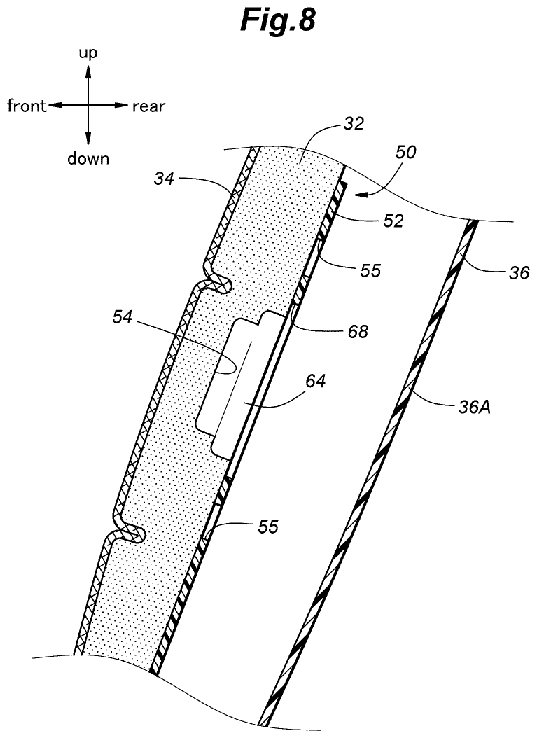

The plate-shaped member 52 of the pressure receiving member 50 may have a different shape. For example, as shown in FIGS. 7 and 8, the plate-shaped member 52 has a hole 68 extending therethrough in the front-rear direction. In addition, the wire 51 is arranged so that the wire 51 does not overlap with the hole 68 as viewed from the front-rear direction. The recess 54 is provided to face the hole 68 in the plate-shaped member 52. As a result, the vibrator 64 is positioned to overlap with the hole 68 in the plate-shaped member 52 as viewed from the front-rear direction. As a result, when being pushed by the back of the occupant, the vibrator 64 is allowed to move rearward through the hole 68 in the plate-shaped member 52, thereby preventing the occupant from feeling uncomfortable in the back by the vibrator 64.

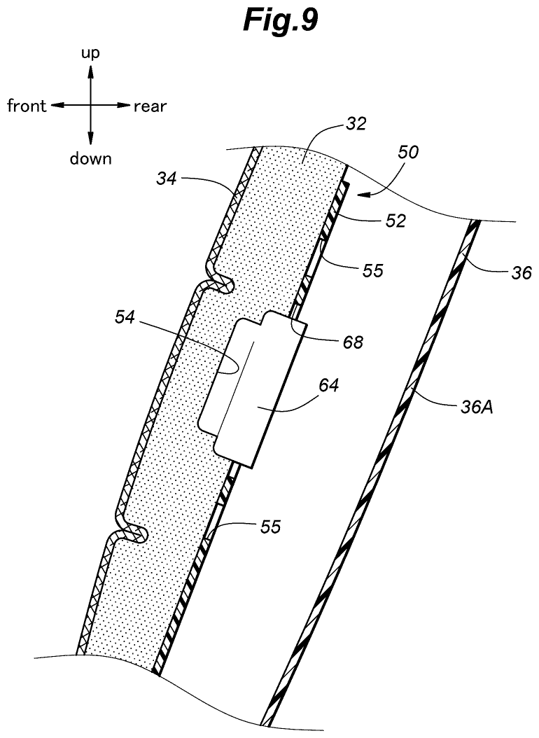

In addition to the above modification to the shape of the plate-shaped member 52, the shape of the recess 54 may have a different shape. For example, as shown in FIG. 9, the depth of the recess 54 may be less than the thickness of the vibrator 64. As a result, a part of the vibrator 64 protrudes from the recess 54. The protruding part of the vibrator 64 passes through the hole 68 in the plate-shaped member 52. This feature that the thickness of the vibrator 64 is greater than the depth of the recess 54 allows the seat back pad 32 to be in contact with the plate-shaped member 52 without interference between the vibrator 64 and the plate-shaped member 52.

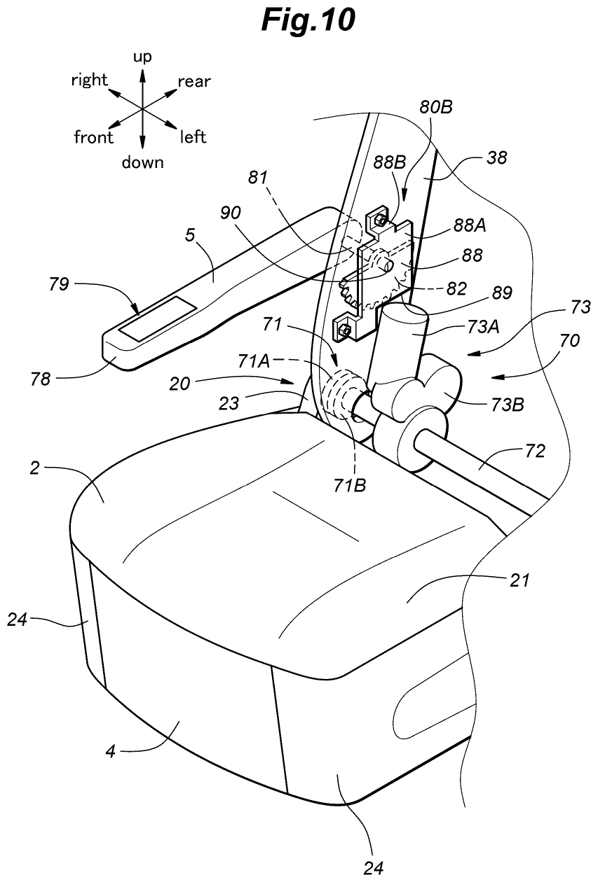

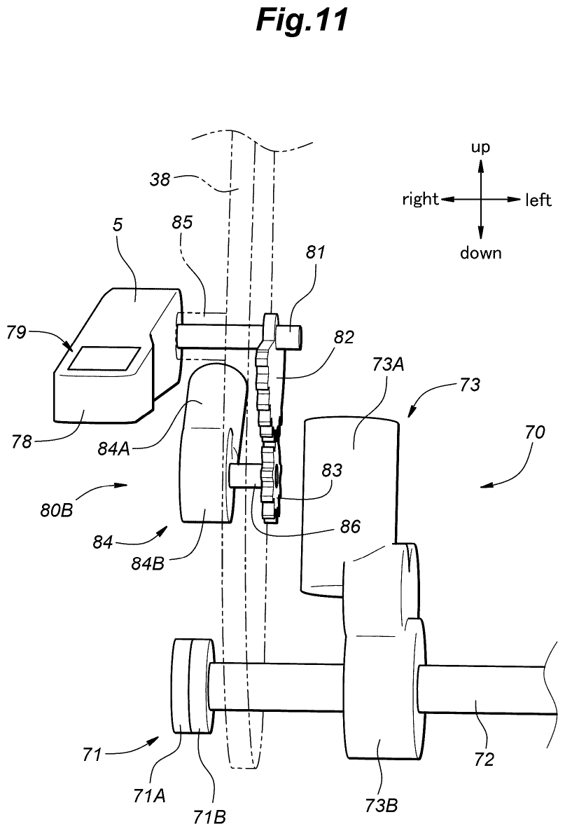

As shown in FIGS. 10 and 11, the seat 1 is provided with a reclining mechanism 70 that allows the seat back 3 to rotate relative to the seat cushion 2. The reclining mechanism 70 includes left and right body parts 71, a drive shaft 72 connected to the left and right body parts 71, and an electric actuator 73 that rotates the drive shaft 72.

Each of the body parts 71 includes with a first member 71A provided with an internal gear and a second member 71B provided with an external gear configured to mesh with the internal gear. The external gear is eccentric with respect to the internal gear. The first member 71A is connected to the rear of the seat cushion side member 23, and the second member 71B is connected to the lower part of the seat back side member 38. The left and right body parts 71 are arranged in a coaxial manner. The drive shaft 72 extends in the left-right direction passing through the left and right seat back side members 38 to be connected to the left and right second members 71B. The electric actuator 73 includes an electric motor 73A and a reduction mechanism 73B which reduces the rotational speed of the electric motor 73A and transmits the rotation to the drive shaft 72. The electric actuator 73 may be arranged on the inner side of either the right or left seat back side member 38. The electric actuator 73 rotates both the left and right second members 71B relative to the corresponding first members 71A via the drive shaft 72. As a result, the seat back 3 rotates relative to the seat cushion 2.

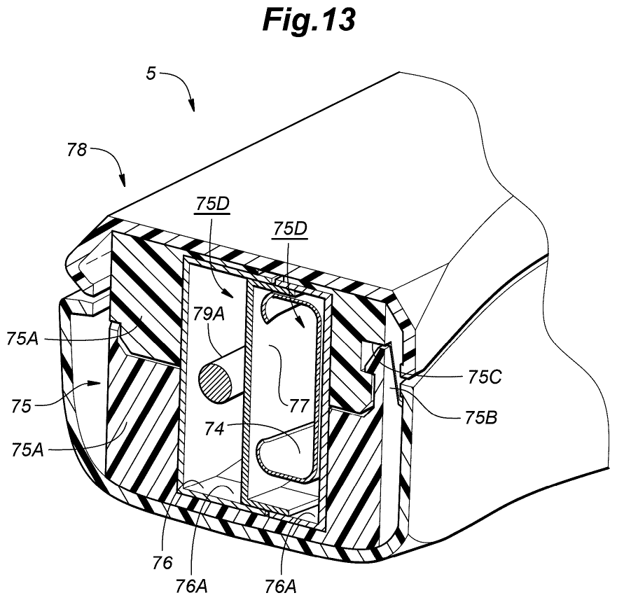

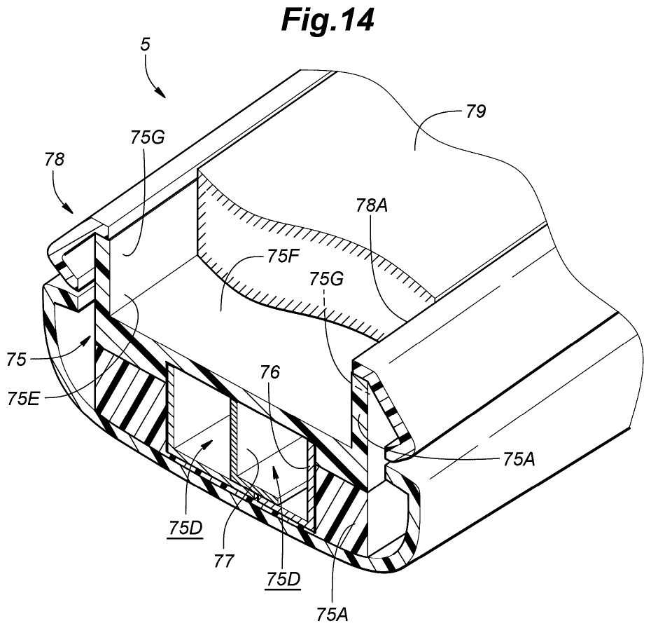

As shown in FIGS. 13 and 14, each of the left and right armrests 5 includes an armrest frame 74 that serves as a structural frame, and an armrest body 75 supported by the armrest frame 74. Each of the armrests 5 further includes an armrest cover 78 that covers the armrest frame 74 and the armrest body 75. One of the left and right armrests 5 is also provided with an input device 79 for receiving operations for controlling a rotation mechanism 80 (described later). In the present embodiment, the right armrest 5 is provided with the input device 79. The input device 79 may also receive operations for controlling the reclining mechanism 70 and the air blowing device 60.

The armrest frame 74 extends in the front-rear direction. The armrest frame 74 is plate-shaped with left-facing and right-facing surfaces. The armrest frame 74 has a length in the front-rear direction that is shorter than that of the armrest 5 in the front-rear direction. The rear end of the armrest frame 74 is connected to a support shaft 81 of the rotation mechanism 80 described below. The armrest frame 74 may be a component manufactured by pressing a metal plate. The armrest frame 74 may, for example, have a main part with left-facing and right-facing surfaces, and side parts extending left and right from the top and bottom ends of the main part, respectively.

The armrest body 75 extends frontward from the front end of the armrest frame 74. The armrest body 75 may have a pair of split bodies 75A each having a U-shaped cross section, for example, extending in the front-rear direction and recessed upward or downward. The armrest body 75 is formed by joining the split bodies 75A such that the openings of the respective split bodies 75A face each other. The pair of split bodies 75A may be joined together, for example, by the catch tabs 75B provided on the lower split body 75A that are caught in the catch recesses 75C formed on the upper split body 75A. As a result, a subspace 75D is formed in the armrest body 75. The armrest frame 74 is provided in the subspace 75D. The armrest body 75 may be formed from a plastic material, for example.

The armrest body 75 further includes a reinforcing member 76. The reinforcing member 76 may be a frame provided along the inner surface that defines the subspace 75D. The reinforcing member 76 may, for example, extend in the front-rear direction, and have a pair of reinforcing member bodies 76A, each being formed in a U-shaped cross-section that is recessed in the left-right direction. The reinforcing members 76 may be formed by joining the reinforcing member bodies 76A such that the respective openings of the reinforcing member bodies 76A face each other.

The armrest body 75 further includes a partition wall 77 that divides the subspace 75D into left and right subspaces. The partition wall 77 is provided in the reinforcing member 76. The partition wall 77 extends in the front-rear direction and is formed as a plate with left-facing and right facing surfaces. The armrest frame 74 is provided in a left or right subspace 75D defined by the partition wall 77. The partition wall 77 may have, for example, a main part with left-facing and right facing surfaces and side parts extending horizontally in the left-right direction from the top and bottom ends of the main part, respectively. The up-facing and down-facing ng surfaces of the upper and lower side parts of the partition wall 77 may be bonded to the corresponding upper and lower inner surfaces of the reinforcing member body 76A. The reinforcing member 76 and partition wall 77 may be made of metal, or may be made of a plastics material that is harder than the armrest body 75. The reinforcing member 76 and the partition wall 77 can receive a vertical load applied to the armrest body 75. As a result, the rigidity of the armrest body 75 is improved.

The armrest body 75 further has a recess 75E that is recessed downward from the top. The recess 75E has a bottom part 75F and a pair of side walls 75G extending upward from the left and right edges of the bottom part 75F. Specifically, the recess 75E is formed in the armrest body 75 and recessed downward from the top surface of the upper split body 75A. The bottom part 75F of the recess 75E has a smaller width than the upper split body 75A in the left-right direction. In the present embodiment, the recess 75E is formed in the armrest body 75 of the right armrest 5. An opening 78A may be formed in a part of the armrest cover 7 where the part overlaps the recess 75E as viewed from above or below.

As shown in FIGS. 10 and 11, each of the armrests 5 is provided with the rotation mechanism 80. The left and right armrest frames 74 are rotatably supported by the corresponding seat back side members 38 via respective support shafts 81. The left armrest 5 is provided with a left rotation mechanism 80A. The right armrest 5 is provided with a right rotation mechanism 80B. The rotation mechanisms 80 rotate the corresponding armrests 5 relative to the seat back 3. The left and right armrests 5 are independently rotatable relative to the seat back 3.

As the left and right rotation mechanisms 80 have the same mechanical structure, the right rotation mechanism 80B will be described below. The (right) rotation mechanism 80 includes a support shaft 81 coupled to the armrest frame 74 of the right armrest 5, a sector gear 82 coupled to the support shaft 81, and an electric actuator 84 provided with a pinion 83 (FIG. 11) that is meshed with the sector gear 82.

A cylindrical bearing 85 that protrudes to the right is provided on the right side of the seat back side member 38 (FIG. 11). The support shaft 81 extends in the left-right direction and is supported by the bearing 85 in a rotatable manner. The right end of the support shaft 81 is connected to the armrest frame 74 of the right armrest 5. The support shaft 81 extends through the seat back side member 38 and protrudes from the left side of the seat back side member 38.

The sector gear 82 is connected to the left end of the support shaft 81. The sector gear 82 extends downward from the support shaft 81.

The electric actuator 84 includes an electric motor 84A, a reduction mechanism 84B, and a pinion 83 coupled to an output shaft 86 of the reduction mechanism 84B. The electric motor 84A and the reduction mechanism 84B are coupled to the outer side of the seat back side member 38 and are arranged between the seat back cover 36 and the seat back side member 38. The output shaft 86 extends in the left-right direction, extends through the seat back side member 38 from the reduction mechanism 84B, and protrudes inward from the seat back side member 38. The output shaft 86 is located lower than the support shaft 81. The pinion 83 is coupled to the end of the output shaft 86. The pinion 83 is positioned below the sector gear 82 and meshes with the sector gear 82.

The armrest cover 78 has a wider width at the front end part than a width at rear end part thereof, where the terms “width”, “outer”, and “inner” are defined along the left-right direction of the seat, as described above. The inner side of the rear end part of the armrest cover 78 is positioned outward of the electric actuator 84 of the rotation mechanism 80. The inner side of the front end part of the armrest cover 78 is positioned to overlap the electric actuator 84 of the rotation mechanism 80, as viewed from the front. The lower part of the side portion 36B bulges outward to receive the electric actuator 84 of the rotation mechanism 80, which allows the armrest 5 to be rotated upward without interference between the armrest 5 and the lower part of the side portion 36B. The right armrest cover 78 has an input device 79 on the top surface thereof.

The electric actuator 84 rotates the support shaft 81 via the pinion 83 and the sector gear 82. The electric actuator 84 rotates the armrest 5 relative to the seat back 3. The armrest 5 may be configured to rotate relative to the seat back 3 at a rotational speed that is generally equal to a rotational speed at which the seat back 3 rotates relative to the seat cushion 2.

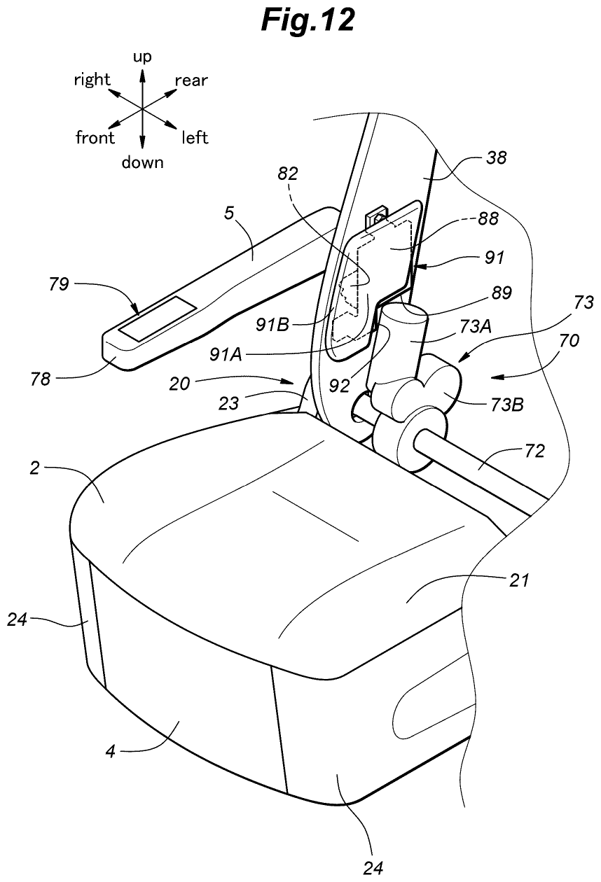

As shown in FIGS. 10 and 12, a bracket 88 and a bracket cover 91 for protecting the sector gear 82 and the pinion 83 are provided on the inner side of the seat back side member 38.

As shown in FIG. 10, the bracket 88 may be formed by the bending and shaping of a metal plate. The bracket 88 has a main part 88A with left-facing surface and right-facing surface and a plurality of legs 88B extending outward of seat from side edges of the main part 88A. The bracket 88 is coupled to the seat back side member 38 at the plurality of legs 88B. The plurality of legs 88B are preferably fastened or welded to the seat back side member 38. The main part 88A is provided with a first notch 89 to avoid interference with the electric actuator 73 of the reclining mechanism 70. The first notch 89 is preferably formed at the lower rear of the main part 88A.

The sector gear 82 and the pinion 83 are arranged between the main part 88A and the seat back side member 38. The end of the support shaft 81 may be supported in a bearing hole 90 formed in the main part 88A. Similarly, the end of the drive shaft 72 may be supported in another bearing hole formed in the main part 88A.

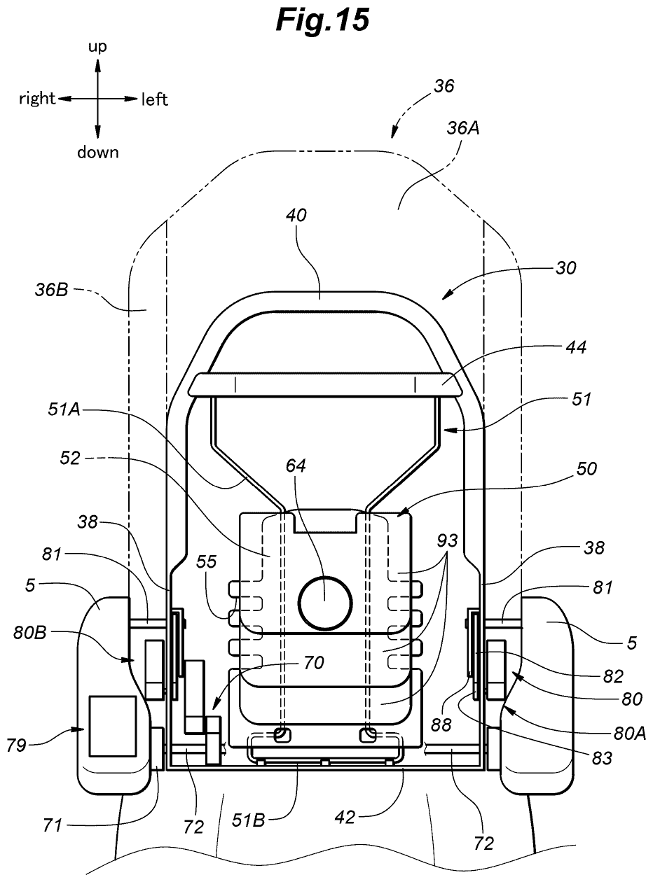

As shown in FIG. 12, the bracket cover 91 is supported by the bracket 88. The bracket cover 91 may be made of a plastics material. The bracket cover 91 has a first part 91A with a left-facing surface and a right-facing surface, and a second part 91B extending outward from the front edge of the first part 91A. The second part 91B has surfaces facing frontward and rearward. The first part 91A is positioned inward of the main part 88A of the bracket 88. The second part 91B is arranged frontward of the sector gear 82 and the pinion 83. The bracket cover 91 has a second notch 92 for avoiding interference with the electric actuator 73 of the reclining mechanism 70. The second notch 92 is preferably formed at the lower rear part of the main part 88A. As shown in FIG. 15, air cells 93 may be provided on the front surface of the plate-shaped member 52 of the pressure receiving member 50. The air cells 93 expand when air is supplied thereto, causing the seat back pad 32 to protrude frontward.

The bracket 88 and the bracket cover 91 prevent the sector gear 82 and the pinion 83 from interfering with the seat back pad 32. The bracket 88 and bracket cover 91 also prevent the sector gear 82 and the pinion 83 located on the right side from interfering with the electric actuator 73 of the reclining mechanism 70.

Examples of the input device 79 may include a touch panel display and a mechanical switch. In the present embodiment, the input device 79 is a touch panel display. Preferably, the display of the input device 79 displays switches for setting the angle of the reclining mechanism 70, the angle of the armrest 5, and the output of the air blowing device 60.

As shown in FIG. 14, the input device 79 is accommodated in the recess 75E formed in the armrest 5. Specifically, the input device 79 is accommodated in the recess 75E in the right armrest body 75 such that the display faces upward. When the input device is received in the recess 75E, the bottom surface of the input device 79, which faces the display, is preferably in contact with the bottom surface of the bottom part 75F of the recess 75E. In addition, the left and right sides of the input device 79 preferably contact the inner surfaces of the corresponding left and right side walls 75G of the recess 75E. In this case, the upper end of the side wall 75G is located above the top of the input device 79. Thus, the display surface of the input device 79 is located below the top of the upper split body 75A, which does not have the recess 75E formed thereon. The input device 79 may be secured to the upper split body 75A by a fastener such as a bolt secured to the bottom part 75F of the recess 75E.

The display surface of the input device 79 is exposed through the opening 78A in the armrest cover 78. The display surface of the input device 79 is below the top surface of the armrest cover 78.

The input device 79 is connected to a harness 79A. The input device 79 is connected to a control device 95 (described later) via the harness 79A. The harness 79A is routed through the subspaces 75D of the armrest body 75. Specifically, the harness 79A is arranged in the left or right subspace 75D, which is formed by the partition wall 77. As the harness 79A is routed through another subspace 75D, which can accommodate the armrest frame 74, the configuration which allows the harness 79A to be placed, can be made simple. Moreover, the partition wall 77 reduces interference between the harness 79A and the armrest frame 74.

When an occupant's arm is placed on the armrest 5 which is configured as described above, a load applied from the above to the armrest 5 is transmitted to the armrest body 75 via the armrest cover 78. Thus, no load is applied to the input device 79, which prevents the occupant's unintended operation from being received.

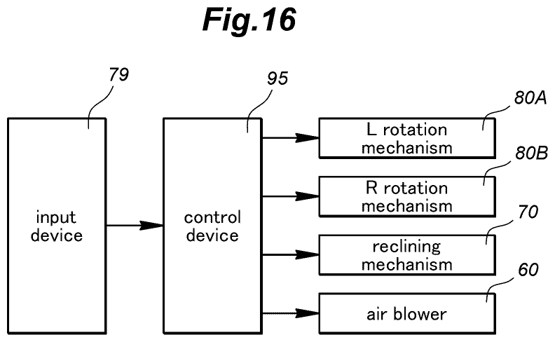

As shown in FIG. 16, a control device 95 is connected to the left and right rotation mechanisms 80A and 80B, the input device 79, the reclining mechanism 70, and the air blowing device 60. The control device 95 is a computer equipped with a processor (such as CPU or MPU) and a memory device (such as ROM or RAM) and configured to perform various processing operations necessary for the armrest 5 and seatback 3 to rotate. The statement that the control device 95 is configured to perform various processing operations, means that an arithmetic processing unit (processor), which is a primary part of the control device 95, is programmed to, in response to an input operation on the input device 79, read necessary data and application software from the memory device (memory), and perform prescribed processing operations according to the application software. The control device 95 may be provided, for example, in the seat cushion 2, in the seat back 3, or in the armrest 5.

The control device 95 controls the left rotation mechanism 80A, the right rotation mechanism 80B, the reclining mechanism 70, and the air blowing device 60 according to control signals from the input device 79. In addition, the control device 95 performs operations of armrest coordination control, which causes the left and right armrests 5 to rotate in response to the rotation of the seat back 3.

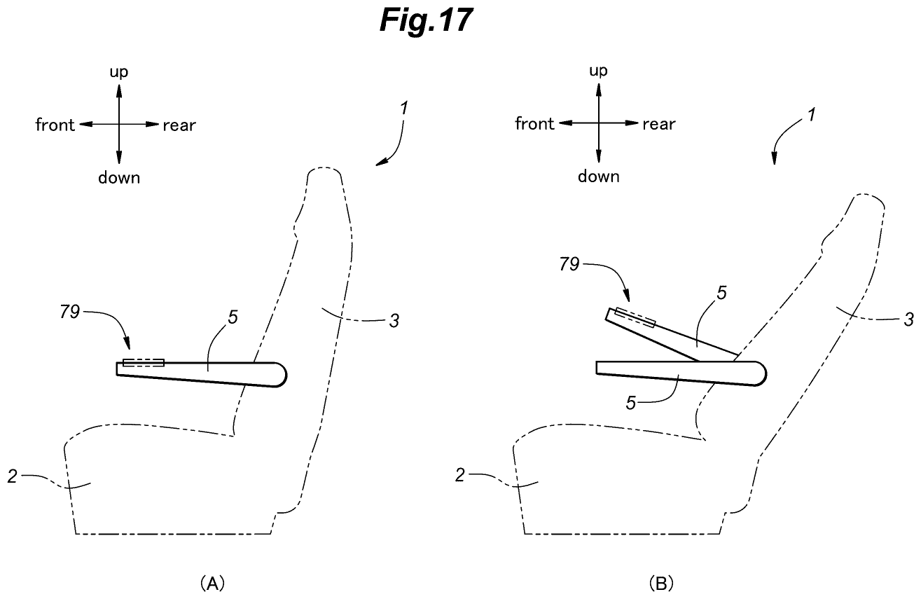

As shown in FIG. 17 (A), when the seat back 3 is in its upright position, which is its initial position, the left and right armrests 5 are in their initial position to extend horizontally. The seat back 3 is preferably tilted rearward by about 10 to 30 degrees at their initial position.

The display of the input device 79, for example, displays a rear rotation switch for rotating the seat back 3 rearward and a front rotation switch for rotating the seat back 3 frontward. The input device 79 outputs a rear rotation signal to the control device 95 while the rear rotation switch is being pressed by an occupant. The input device 79 also outputs a front rotation signal to the control device 95 while the front rotation switch is being pressed by an occupant.

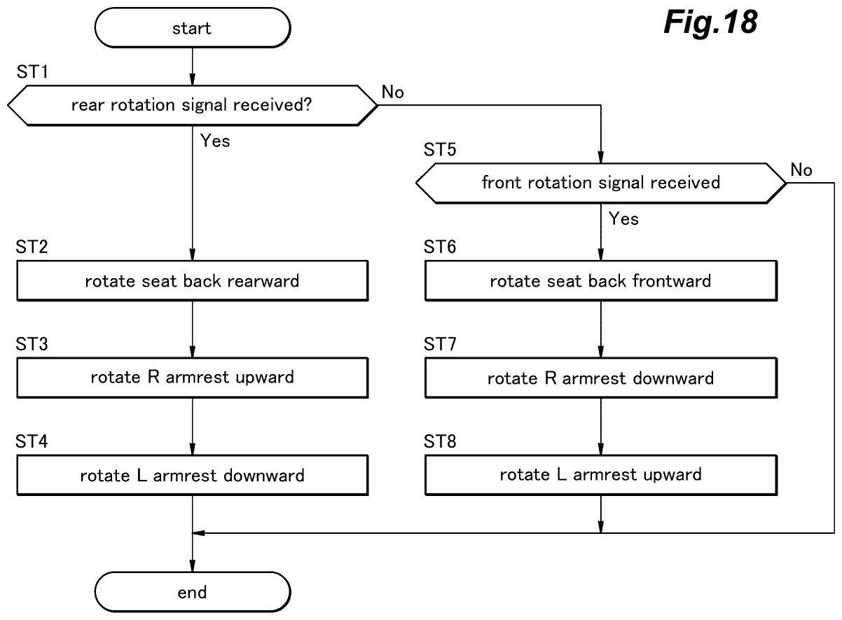

The control device 95 performs operations of the armrest coordination control as shown in FIG. 18. First, the control device 95 determines whether or not the control device 95 has received a rear rotation signal from the input device 79 (ST1). When determining that a rear rotation signal has been received (Yes in ST1), the control device 95 drives the electric motor 73A of the reclining mechanism 70 in order to rotate the seat back 3 rearward (ST2). Next, the control device 95 drives the electric motor 84A of the right rotation mechanism 80B in order to rotate the right armrest 5 upward (ST3). Next, the control device 95 drives the electric motor 84A of the left rotation mechanism 80A in order to rotate the left armrest 5 downward (ST4).

When determining that a rear rotation signal has not been received (No in ST1), the control device 95 determines whether or not the control device 95 has received a front rotation signal from the input device 79 (ST5). When determining that a front rotation signal has not been received (Yes in ST5), the control device 95 drives the electric motor 73A of the reclining mechanism 70 in order to rotate the seat back 3 frontward (ST6). Next, the control device 95 drives the electric motor 84A of the right rotation mechanism 80B in order to rotate the right armrest 5 downward (ST7). Next, the control device 95 drives the electric motor 84A of the left rotation mechanism 80A in order to rotate the left armrest 5 upward (ST8).

When determining that a front rotation signal has not been received (No in ST5), the control device 95 does not drive the electric motor 73A of the reclining mechanism 70, the electric motor 84A of the right rotation mechanism 80B, and the electric motor 84A of the left rotation mechanism 80A.

The control device 95 performs operations of the armrest coordination control, whereby when the seat back 3 rotates rearward, the right armrest 5 rotates upward and the left armrest 5 rotates downward, as shown in FIG. 17(B). This allows the display of the input device 79 to be positioned such that, when the seat back 3 is reclined, an occupant can easily see the display of the input device 79. Thus, this configuration improves the operability of the input device 79. In addition, the left armrest 5 extends horizontally and can support the occupant's left arm, thereby allowing the occupant to rest the left arm.

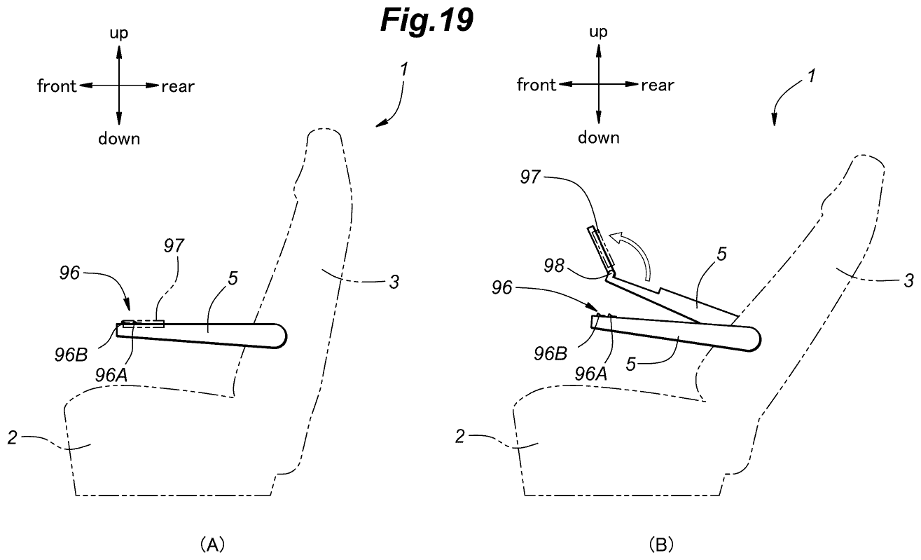

The input device 79 may be configured differently. For example, as shown in FIG. 19, an input device 96 may be provided on the left armrest 5. The input device 96 is a mechanical switch. The input device 96 may receive operations for controlling the rotation of the reclining mechanism 70. The input device 96 has a rear rotation switch 96A for rotating the seat back 3 rearward and a front rotation switch 96B for rotating the seat back 3 frontward. The rear rotation switch 96A is preferably provided rearward of the front rotation switch 96B.

The right armrest 5 is provided with a display 97. The display 97 may display the temperature in the vehicle, or other data. The front end of the display 97 may be connected to the armrest cover 78 via connecting means such as a hinge 98. This feature allows the display 97 to be rotatable with respect to the armrest cover 78. The angle at which the display 97 rotates may be adjusted as appropriate. The display 97 rotates between an accommodation position in which the display 97 extends along the top surface of the armrest cover 78 and a use position in which the display 97 extends upward from the armrest cover 78 and faces an occupant.

The control device 95 may perform operations to cause the right armrest 5 having the display 97 to rotate upwards and causes the left armrest 5 to rotate downward, in response to the rearward rotation of the seat back 3 . This feature allows the display 97 to be positioned such that an occupant can easily see the display of the input device 79 when the seat back 3 is reclined (FIG. 17 (B)). In addition, the left armrest 5 extends horizontally and is configured to support an occupant's left arm.

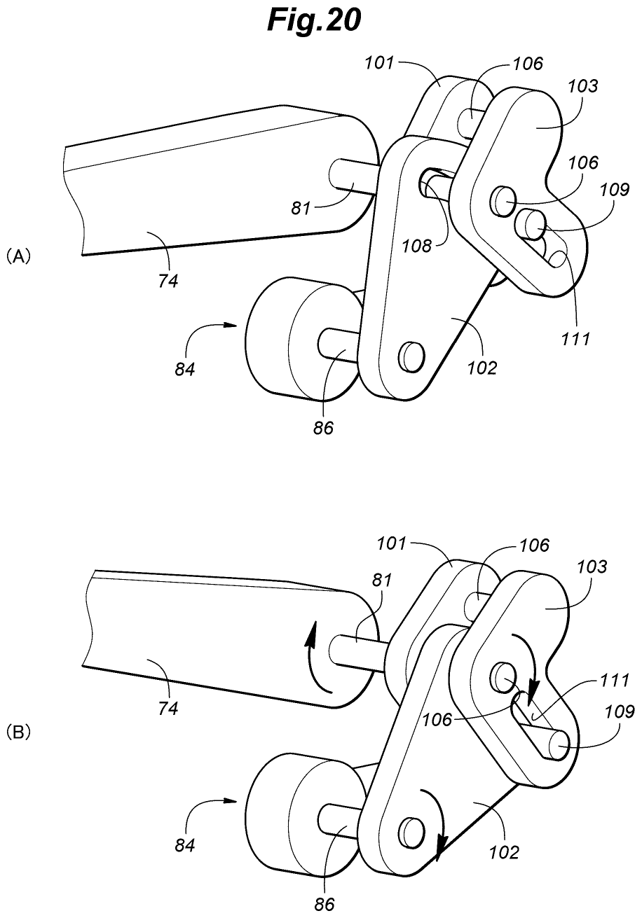

The rotation mechanisms 80 for rotating the corresponding armrests 5 may be differently configured. For example, as shown in FIG. 20, each of the rotation mechanisms 80 includes a support shaft 81 coupled to the armrest frame 74 of the armrest 5, a first bracket 101 coupled to the support shaft 81, a second bracket 102 connected to the output shaft 86 of the electric actuator 84 and to the first bracket 101, and a third bracket 103 for supporting the first bracket 101 and the second bracket 102.

The first bracket 101 is plate-shaped with left-facing and right-facing surfaces. The first bracket 101 is provided with a plurality of first connecting pins 106 that extend inward. In the present embodiment, the first bracket 101 is provided with two first connecting pins 106.

The second bracket 102 is plate-shaped with left-facing and right-facing surfaces. The second bracket 102 is positioned laterally inward of the first bracket 101. The second bracket 102 is formed with a first slot 108 extending therethrough in the thickness direction. The first slot 108 is provided upward of the output shaft 86 of the electric actuator 84. One of the plurality of first connecting pins 106 on the first bracket 101 is provided to pass through the first slot 108. As shown in FIG. 20(A), when the armrest 5 is at its initial position, in which the armrest 5 extends horizontally, the first slot 108 extends downward at an angle toward the rear. When the armrest is in this state, the first connecting pin 106 extending through the first slot 108 is preferably positioned at the rear end of the first slot 108. In addition, the second bracket 102 is provided with a second connecting pin 109 extending inward. The second connecting pin 109 is located rearward of the rear end of the first slot 108.

The third bracket 103 is plate-shaped with left-facing and right-facing surfaces. The third bracket 103 is positioned laterally inward of the second bracket 102. The third bracket 103 is formed with a second slot 111 extending therethrough in the thickness direction. The second connecting pin 109 is provided to pass through the second slot 111. As shown in FIG. 20(A), when the armrest 5 is at its initial position, in which the armrest 5 extends horizontally, the second slot 111 extends downward at an angle toward the rear. When the armrest 5 is in this state, the second connecting pin 109 is preferably positioned at the front end of the second slot 111. A screw thread may be formed at the tip part of the second connecting pin 109. In this case, after the second connecting pin 109 has passed through the second slot 111, a nut (not shown) may be screwed onto the screw thread formed at the tip of the second connecting pin 109. This feature allows the third bracket 103 to support the second bracket 102.

In addition, a screw thread may be formed at the tip of each of the first connecting pins 106 provided on the first bracket 101. The third bracket 103 may have a plurality of fastening holes (not shown) extending in the thickness direction, through which the corresponding first connecting pin 106 passes. After one of the first connecting pins 106 has passed through the corresponding fastening hole, a nut (not shown) may be screwed onto the thread of the first connecting pin 106. The other first connecting pin 106 may extend through the first slot 108 and a corresponding fastening hole, so that a nut (not shown) is screwed onto the thread. These features cause the first bracket 101 and the second bracket 102 to be supported by the third bracket 103.

The electric actuator 84 rotates the first bracket 101 via the output shaft 86. As shown in FIG. 20(B), the rotation of the first bracket 101 causes the first connecting pin 106 and the second connecting pin 109 to be displaced, resulting in the rotation of the support shaft 81. This causes the armrest 5 to rotate with respect to the seat back 3.

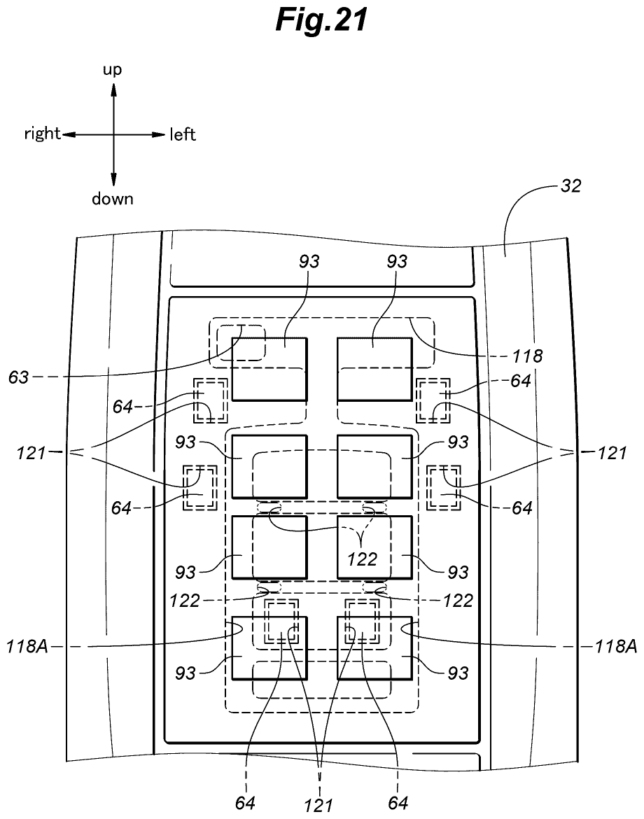

The air blowing device 60, the vibrators 64 and the air cells 93 may be configured and arranged differently. For example, as shown in FIG. 21, the seat back pad 32 may have an air passage groove 118 communicatively connected to the air outlet 63 of the air blowing device 60. The air passage groove 118 extends across a plane along the surface of the seat back pad 32. The air outlet 63 is preferably positioned in a bottom part of the air passage groove 118 as viewed from the front-rear direction. In the present embodiment, the air outlet 63 is formed at the top of the seat back pad 32, and the air passage groove 118 extends downward from the air outlet 63. The air passage groove 118 has a plurality of vertical grooves 118A extending in the vertical direction of the seat back pad 32. The vertical grooves 118A are formed in a width center part of the seat back pad 32. In the present embodiment, the two vertical grooves 118A are provided with a distance therebetween in the left and right direction. The air passage groove 118 may be recessed rearward from the front of the seat back pad 32. Alternatively, the air passage groove 118 may be provided in a plate-shaped pad cover member (not shown) that partially covers the seat back pad 32.

A plurality of vibrators 64 are provided in the seat back pad 32. Each of the vibrators 64 is accommodated in a corresponding accommodation recess 121 formed in the seat back pad 32. The accommodation recess 121 is recessed rearward from the front of the seat back pad 32. Each accommodation recess 121 is formed to extend, avoiding the air passage groove 118. When the air passage groove 118 is provided in the pad cover member that partially covers the seat back pad 32, the pad cover member may be provided with an accommodation recess 121.

In the present embodiment, three vibrators 64 are vertically arranged on either side part of the seat back pad 32. Specifically, of the three vibrators 64 arranged on each of the left and right sides, two vibrators 64 are located outward of a corresponding one of the left and right vertical grooves 118A. The remaining one vibrator 64 of the three vibrators 64 in either side part is arranged between the two vertical grooves 118A.

A plurality of air cells 93 are provided at positions frontward of the air passage groove 118. In this case, the air cells 93 are arranged such that any of the air cells 93 does not overlap the air passage groove 118 or the vibrator 64 as viewed from the front.

The seat back 3 may include a cover (not shown) that covers the air passage grooves 118, accommodation recesses 121, and air cells 93, from the front. The cover may be formed as a plate having a front-facing surface and a rear-facing surface. The cover may have a plurality of through-holes 122 extending therethrough in the front-rear direction. The plurality of through-holes 122 are formed in the cover such that the through-holes 122 overlap the air passage grooves 118, as viewed from the front-rear direction, and do not overlap any of the air cells 93. Air blown out from the blower 61 flows toward an occupant, passing through the duct 62, the air outlet 63, the air passage grooves 118, and the through-holes 122.

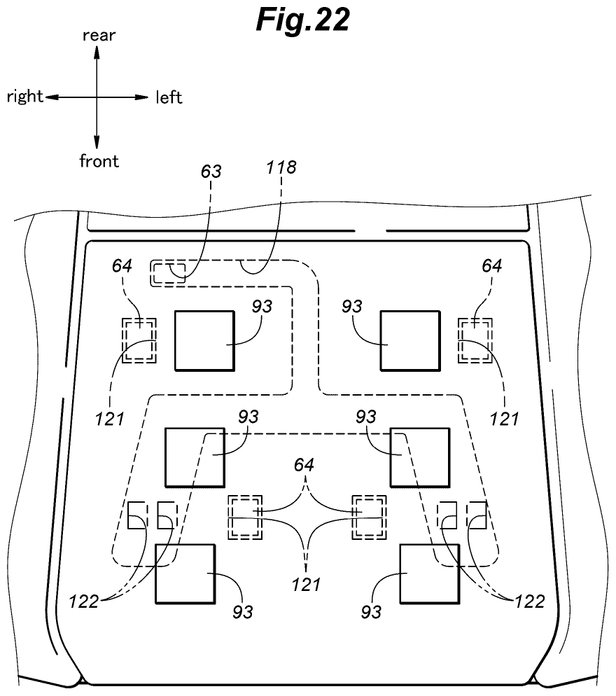

In other embodiments, the air outlet 63 of the air blowing device 60, the air passage grooves 118, the vibrators 64, and the air cells 93 may be provided in the seat cushion 2, as shown in FIG. 22. In this case, the air passage grooves 118 and the accommodation recesses 121 that accommodate the vibrators 64 may be formed in the seat cushion pad 21 or may be formed in the pad cover member (not shown) that partially covers the seat cushion pad 21.

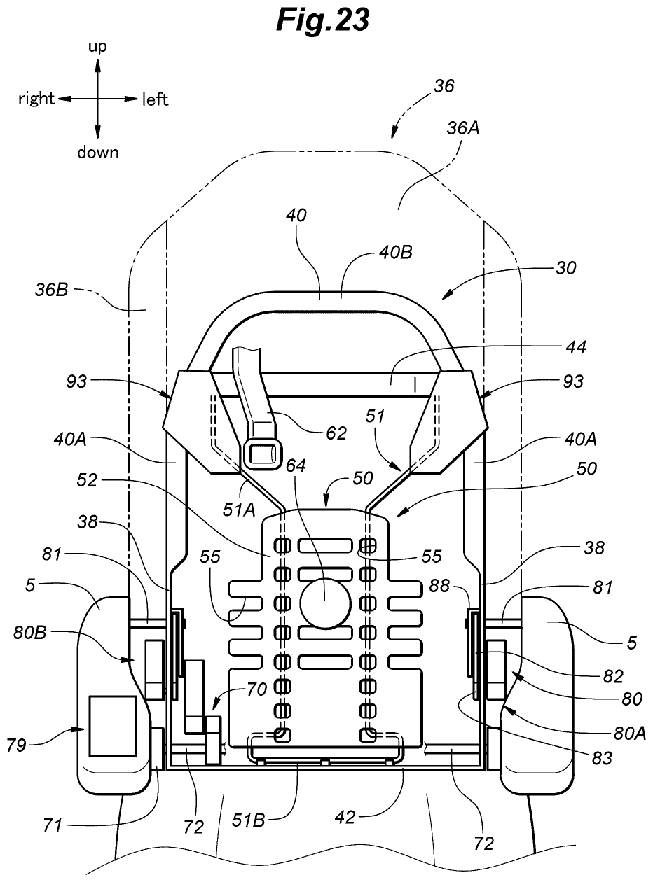

The air blowing device 60 and the air cells 93 may be configured and arranged differently. For example, as shown in FIG. 23, the upper member 40 has a pair of vertical portions 40A extending upward from the upper ends of the left and right seat back side members 38, and a horizontal portion 40B extending in the left-right direction and connecting the upper ends of the left and right vertical portions 40A. The air cells 93 are arranged in each of the left and right vertical portions 40A. The air cells 93 are provided between the pressure receiving member 50 and the seat back pad 32. Each of the air cells 93 bulges out inward in the left-right direction) and downward when fluid is supplied thereto. The second end of the duct 62, which is inserted into the air outlet 63 formed in the seat back pad 32, is located near one of the left and right air cells 93. In the present embodiment, the second end of the duct 62 is located near the right air cell 93. The second end of the duct 62 is located to overlap the right air cell 93, as viewed from the left-right direction.

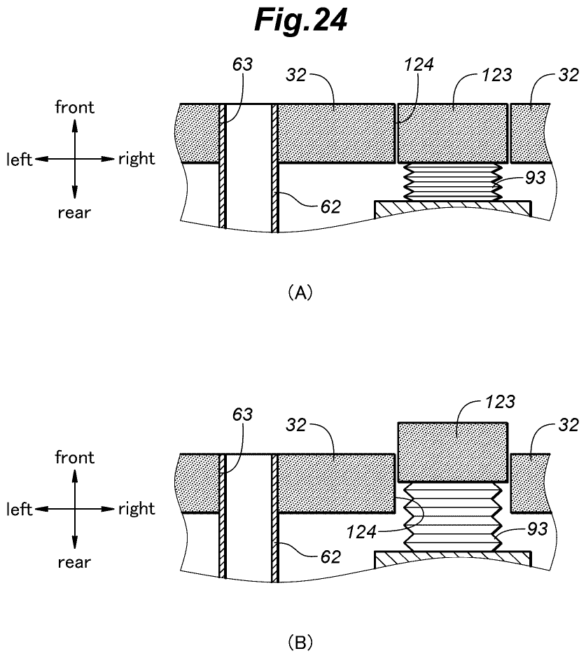

As shown in FIG. 24, the seat back pad 32 may have a plurality of segments 123. Each segment 123 may be formed as an inner part of frame-shaped slits 124 formed in the seat back pad 32. As a result, each segment 123 is movable in the front-rear direction with respect to the seat back pad 32. Each segment 123 may overlap a corresponding one of the left and right air cells 93 as viewed from the front. Each of the segments 123 may be bonded to a corresponding one of the air cells 93. As shown in FIG. 24 (A), when each air cell 93 is not inflated, the front surface of a corresponding one of the segments 123 preferably flushes with the front of the seat back pad 32. As shown in FIG. 24 (B), when each air cell 93 is inflated, a corresponding one of the segments 123 moves frontward with respect to the seat back pad 32. As a result, when the air cell 93 which is located near the air outlet is inflated, the second end of the duct 62 located near the right air cell 93 is prevented from protruding from the air outlet 63.

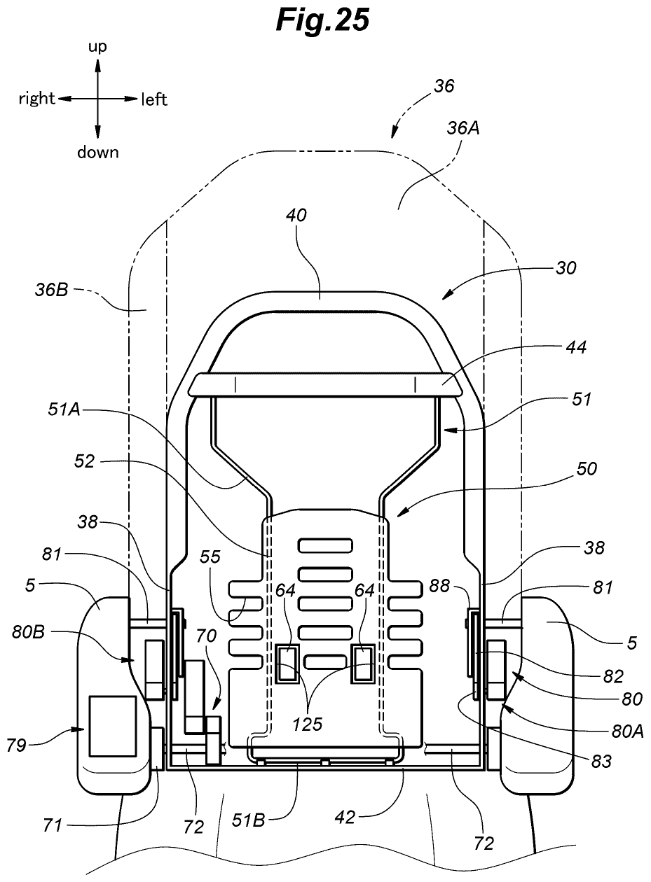

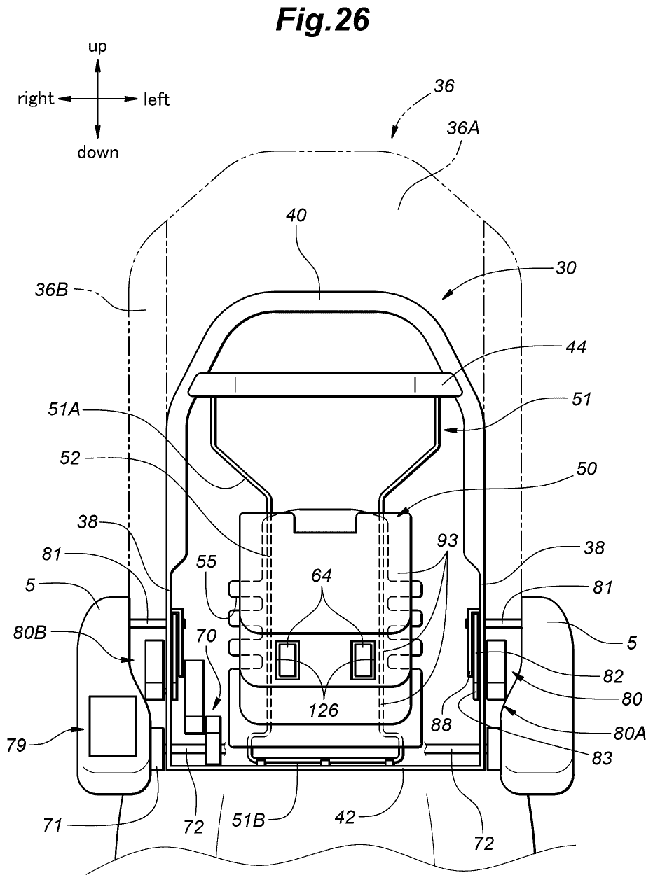

The vibrators 64 may be arranged differently. For example, as shown in FIG. 25, one vibrator 64 is arranged on each of the left and right edges of the seat back pad 32. Each vibrator 64 may be accommodated in an accommodation recess (not shown) on the rear surface of the seat back pad 32. When viewed from the front-rear direction, both the left and right vibrators 64 overlap the plate-shaped member 52 of the pressure receiving member 50. A plurality of openings 125 extend in the front-rear direction through a portion of the plate-shaped member 52 of the pressure receiving member 50, which faces the vibrators 64. As shown in FIG. 26, the plurality of air cells 93 may be provided between the pressure receiving member 50 and the seat back pad 32. In this case, openings 126 may be formed to extend in the front-rear direction through the portions of the air cells 93, overlapping the openings 125 formed in the plate-shaped member 52. This allows the vibrators 64, when being pushed by the back of an occupant, to move rearward through the openings 125 formed in the air cells 93 and the opening 126 formed in the plate-shaped member 52, thereby preventing the occupant from feeling uncomfortable in the back by the vibrator 64.

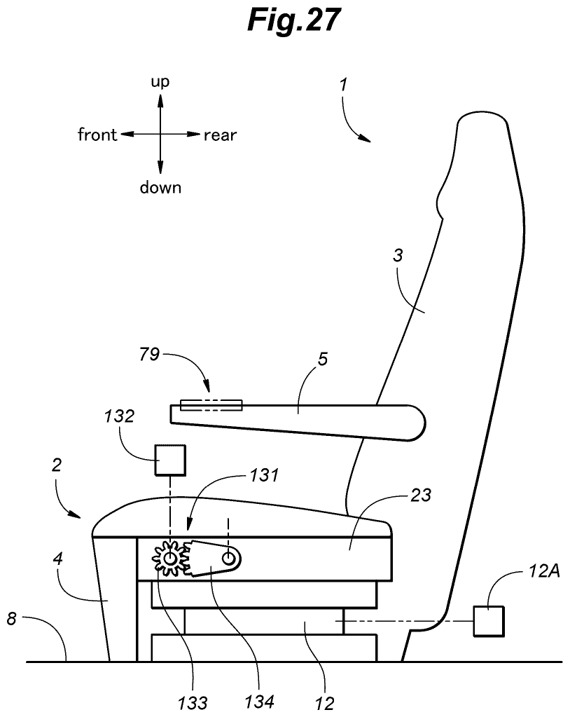

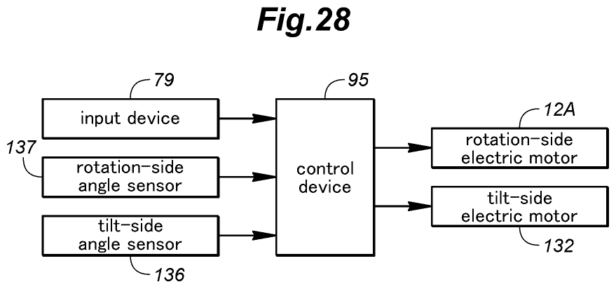

The seat 1 may have a tilt mechanism 131 for rotating a front part of the seat cushion 2 in the up-down direction. As shown in FIG. 27, the tilt mechanism 131 may have a known configuration, which includes, for example, a pinion gear 133 connected to an output shaft of a tilt-side electric motor 132, a sector gear 134 meshing with the pinion gear 133, and a push-up link (not shown) connected to the sector gear 134 and capable of rotating up and down relative to the seat cushion side members 23. The push-up link may be connected to a pan frame (not shown) provided to extend across the front ends of the left and right seat cushion side members 23. The tilt-side electric motor 132 rotates the front part of the seat cushion 2 via the pinion gear 133, the sector gear 134, the push-up link, and the pan frame. The tilt mechanism 131 may also have a tilt-side angle sensor 136 (FIG. 28) for detecting the angle of the front part of the seat cushion 2 with respect to the horizontal direction.

The ottoman 4 may also rotate vertically in conjunction with the vertical rotation of the front part of the seat cushion 2. When the front part of the seat cushion 2 is in its initial position in which the front part extends horizontally, the lower end part of the ottoman 4 may be in contact with the floor 8. As a result, the seat cushion 2 is supported by the ottoman 4 in addition to the rotating device 6, which enables the seat 1 to be supported by the floor 8 in a more stable manner. When the front part of the seat cushion 2 rotates upward, the ottoman 4 also rotates upward. In this state, the lower end part of the ottoman 4 loses contact with the floor 8.

The rotating device 6 for horizontally rotating the seat 1 relative to the floor 8 may have a rotation-side electric motor 12A as the rotation drive mechanism 12 that rotates the support member 11 relative to the base member 10. The rotating device 6 may also have a rotation-side angle sensor 137 (FIG. 28) for detecting the angle of the seat 1 relative to the floor 8.

As shown in FIG. 28, the control device 95 may be connected to the input device 79, which is a touch display, a tilt-side angle sensor 136, a rotation-side angle sensor 137, a tilt-side electric motor 132, and a rotation-side electric motor 12A. The touch display of the input device 79 may display a rotation switch for rotating the seat 1 relative to the floor 8.

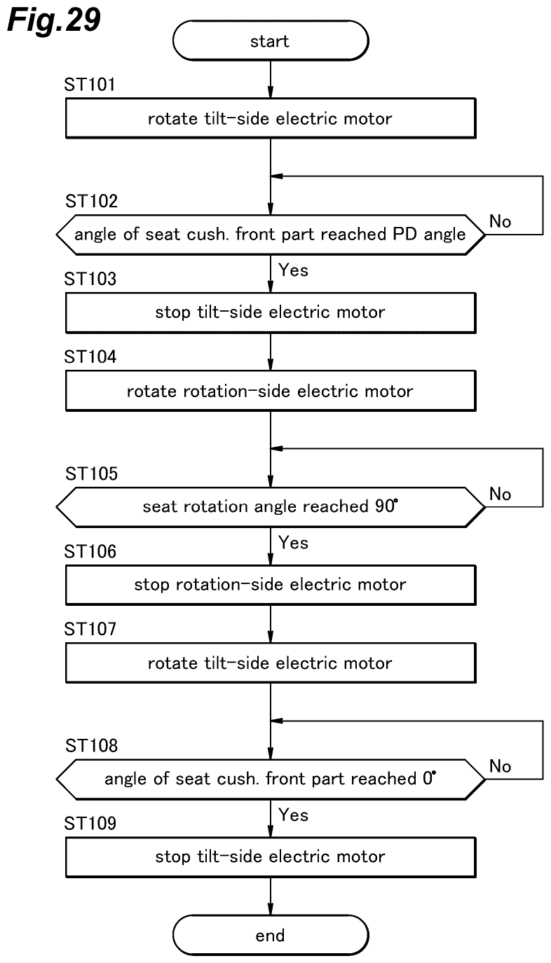

The control device 95 performs operations of rotation control for rotating the seat 1 based on signals from the input device 79. As shown in FIG. 29, first, the control device 95 drives the tilt-side electric motor 132 that rotates a front part of the seat cushion 2 upward (ST101). When the control device 95 determines, based on signals from the tilt-side angle sensor 136, that the rotation angle of the front part of the seat cushion 2 relative to the horizontal direction has reached a predetermined angle (YES in ST102), the control device 95 stops driving the tilt-side electric motor 132 (ST103). The predetermined angle may be an angle at which the lower end of the ottoman 4 loses contact with the floor 8. Then, the control device 95 drives the rotation-side electric motor 12A that rotates the seat 1 (ST104). When the control device 95 determines, based on signals from the rotation-side angle sensor 137, that the rotation angle of the seat 1 has reached 90 degrees (Yes in ST105), the control device 95 stops driving the rotation-side electric motor 12A (ST106). Next, the control device 95 drives the tilt-side electric motor 132 that rotates the front part of the seat cushion 2 downward, i.e., to return the front part of the seat cushion 2 to its initial position (ST107). When the control device 95 determines, based on signals from the tilt-side angle sensor 136, that the rotation angle of the front part of the seat cushion 2 relative to the horizontal direction has reached 0 degrees (YES in ST108), the control device 95 stops driving the tilt-side electric motor 132 (ST109). Before horizontal rotation of the seat 1, the bottom end of the ottoman 4 loses contact with the floor 8, which avoids causing friction between the bottom end of the ottoman 4 and the floor 8. Thus, when the seat 1 horizontally rotates relative to the floor 8, this configuration prevents interference between the ottoman 4 and the floor 8.

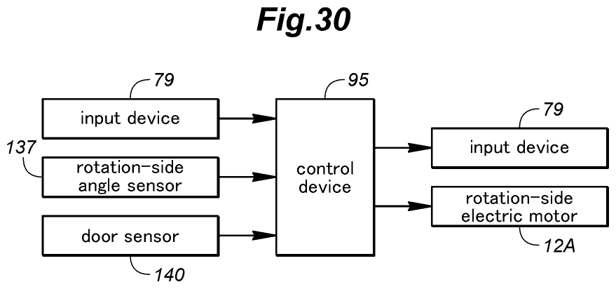

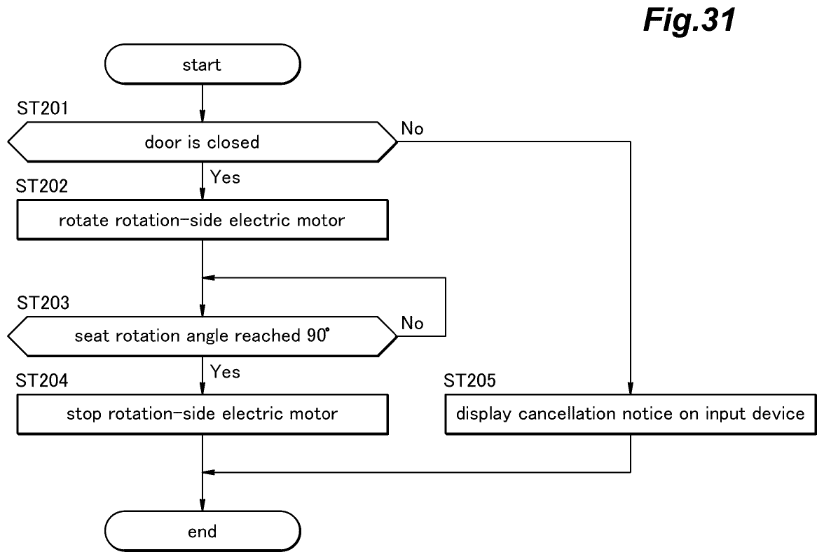

As shown in FIG. 30, a door sensor 140 for detecting whether a vehicle door opens or closes may be connected to the control device 95. The control device 95 performs operations of rotation control for rotation of the seat 1 based on signals from the input device 79, which is a touch display in this case. As shown in FIG. 31, first, the control device 95 determines whether the door is closed based on signals from the door sensor 140 (ST201). When determining that the door is closed (Yes in ST201), the control device 95 drives the rotation-side electric motor 12A to rotate the seat 1 (ST202). When the control device 95 determines, based on signals from the rotation-side angle sensor 137, that the rotation angle of the seat 1 has reached 90 degrees (Yes in ST203), the control device 95 stops driving the rotation-side electric motor 12A (ST204). When the door is not closed (No in ST201), the control device 95 does not drive the rotation-side electric motor 12A. In this state, the control device 95 displays a cancellation notice on the display of the input device 79, the cancellation notice indicating that the rotation-side electric motor 12A is not to be driven (ST205). The cancellation notice may preferably include a release switch for switching the display of the cancellation notice to the display of the rotation switch again.

Specific embodiments of the present invention are described above. However, those embodiments are non-limiting, and various modifications may be made to the embodiments without departing from the scope of the present invention. For example, although the vibrators 64 are provided in the seat back pad 32 in the present embodiment, those devices may be provided in the seat cushion pad 21.

### GLOSSARY

1 seat
2 seat cushion
3 seat back
3A body
3B headrest
3C neck pillow
5 armrest
30 seat back frame (frame)
32 seat back pad (pad)
36 seat back cover (back cover)
50 pressure receiving member
51 wire
52 plate-shaped member
55 cutout hole (cutout)
63 air outlet
64 vibrator
65 sheet
68 hole
74 armrest frame
75 armrest body
75D space
75E recess
75F bottom part
75G side part
76 reinforcing member
77 partition wall
79 input device
79A harness

1. A vehicle seat comprising:
a frame;
a pad supported by the frame and having a recess on a rear surface thereof;
a vibrator disposed in the recess; and
a sheet adhesively attached to the rear surface of the pad and spanning across the recess and the vibrator.

2. The vehicle seat as claimed in claim 1, wherein the sheet is an adhesive tape and adhesively attached to the rear surface of the pad and the vibrator.

3. The vehicle seat as claimed in claim 1, wherein the vibrator is fitted into the recess.

4. The vehicle seat as claimed in claim 1, wherein the pad and the frame form a seat back that supports the back of an occupant, and
wherein the vehicle seat further comprises a back cover that is provided rearward of the frame with a gap therebetween.

5. The vehicle seat as claimed in claim 1, further comprising a pressure receiving member in the frame,
wherein the pressure receiving member supports the rear surface of the pad from the rear, and
wherein the pressure receiving member and the vibrator face each other in a front-rear direction.

6. The vehicle seat as claimed in claim 5, wherein the pressure receiving member comprises a metal wire that spans across the frame, and a plate-shaped member supported by the metal wire and having surfaces that face front and rear, and
wherein the plate-shaped member and the vibrator face each other in the front-rear direction.

7. The vehicle seat as claimed in claim 6, wherein the plate-shaped member has a plurality of wall cutouts in a portion opposite the vibrator.

8. The vehicle seat as claimed in claim 1, further comprising a pressure receiving member in the frame,
wherein the pressure receiving member has a hole extending therethrough in a front-rear direction,
wherein the pressure receiving member supports the rear surface of the pad from the rear, and
wherein the vibrator is located to overlap the hole as viewed from the front or rear side.

9. The vehicle seat as claimed in claim 8, wherein the vibrator protrudes from the recess and extends through the hole.

10. The vehicle seat as claimed in claim 1, wherein the pad and the frame form a seat back that supports the back of an occupant, and
wherein the seat back includes a main body, a headrest integrally provided at an upper end of the main body, a neck pillow provided frontward of and extending over an upper portion of the main body and a lower portion of the headrest, the neck pillow projecting frontward with respect to the main body and the headrest,
wherein the neck pillow has an air outlet at a lower edge portion thereof, and
wherein the vibrator is located downward of the air outlet.
